(19) United States
(12) Patent Application Publication
(10) Pub. No.: US 2005/0034264 A1
(43) Pub. Date: Feb. 17, 2005

(54) System and method for foaming

(75) Inventors: Masakazu Shioyama, Tokyo (JP); Hiroo Yasuda, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: YUSHIRO CHEMICAL INDUSTRY Co., LTD., Tokyo (JP); SHIN NIHON KAGAKU KOGYO Co., LTD., Higashiosaka-shi (JP)

(21) Appl. No.: 10/842,429

(22) Filed: May 11, 2004

(30) Foreign Application Priority Data
May 12, 2003 (JP) 2003-133523
Jun. 9, 2003 (JP) 2003-164350
Dec. 18, 2003 (JP) 2003-421630

(51) Int. Cl. A47L 5/38

(52) U.S. Cl. 15/302

(57) ABSTRACT

This invention concerns a foaming system and foaming method having a simple and cheap structure capable of supplying foamed surface active agent solution to a relatively wide supply object uniformly with an excellent foaming condition. This foaming system (floor surface cleaning system 1) comprises: a plurality of foaming means (foaming devices 2a-2d) for foaming surface active agent solution; foamed liquid supply means for supplying the surface active agent solution foamed by the plurality of foaming means to a supply object (floor surface F); a surface active agent supply means (liquid supply pipe 13) for supplying the surface active agent solution to the plurality of foaming means; a gas supply means (air supply pipe 26) for supplying gas to the plurality of foaming means; and a water supply means (liquid supply pipe 13) for supplying water to said supply object. The foamed liquid supply means includes a plurality of pipe-like members (division pipes 6a-6d) corresponding to the plurality of foaming means.

### BACKGROUND OF THE INVENTION

1. Field of the Invention

The present invention relates to a foaming system and a foaming method and more particularly to a foaming system and foaming method having a simple and cheap structure capable of supplying foamed surface active agent uniformly to a relatively wide range of a supply object with an excellent foaming condition.

The foaming system means a system for covering the supply object with foamed liquid and removing the covering foamed liquid. Further, the foaming method means a method for covering the supply object with foamed liquid or removing the covering foamed liquid.

The present invention is widely applicable for, for example, cleaning procedure for a galley, toilet, bath room, factory, garbage pit, disinfectant treatment, sanitation treatment, harmful insect removal, spraying of agricultural chemical and the related fields.

2. Description of the Related Art

Conventionally, there has been well known a floor surface cleaning system for galley, which comprises a foaming device 3 (foaming device) capable of foaming cleaning liquid, a supply means (pressure feeding pump 4, connecting pipe 8, control unit 20 and the like) for supplying cleaning liquid or water to this foaming device and a supply pipe (distribution pipe 5) which is connected to this foaming device and disposed along four sides of a room (see patent document 1).

According to this floor surface cleaning system, first, cleaning liquid is supplied to the foaming device and this foamed cleaning liquid is sprayed to the floor surface through a number of supply ports (discharge ports 6a-6g) provided in a supply pipe through a connecting pipe and then left under that spraying condition for a while. After that, water supplied to the foaming device is sprayed to the floor surface from the supply ports of the supply pipe through the connecting pipes so as to wash out contamination on the floor surface with the cleaning liquid.

Patent document: Japanese Utility Model No.HEI5-13344

Because according to the aforementioned conventional floor surface cleaning system, a continuous supply pipe connected to the foaming device is disposed along four sides of a floor surface, the cleaning liquid in the foamed condition supplied to the supply pipe through the foaming device has a high pressure at a portion in the vicinity of the foaming device while the supply pressure at a portion far away the foaming device is low. Therefore, in the conventional floor surface cleaning system, if the floor surface of a room, which is a supply object is relatively wide, it is difficult to supply foamed cleaning liquid uniformly to the floor surface with an excellent foaming condition.

Further, the conventional system requires a number of supply ports provided in the supply pipe to be constructed in the form of a nozzle mechanism capable of adjusting the amount of discharge and further, a complicated nozzle adjustment work for spraying foamed cleaning liquid uniformly on the floor surface to be executed.

Further, if an entrance or exit such as a door is provided in a room which is a cleaning object, it is necessary to provide that corresponding part (portion corresponding to the entrance/exit) of a continuous supply pipe under the floor surface, thereby leading to a rise in production cost.

Further, according to the conventional floor surface cleaning system, the foamed cleaning liquid supplied to the supply pipe for a next cleaning work is diluted with water remaining in the supply pipe used in a current cleaning work, so that sometimes the cleaning liquid to be sprayed to the floor surface is not changed to an excellent foaming state.

### SUMMARY OF THE INVENTION

Accordingly, the present invention has been accomplished in views of those current condition and an object of the invention is to provide a foaming system and foaming method having a simple and cheap structure capable of supplying foamed surface active agent solution to a relatively wide supply object with an excellent foaming condition.

The present invention has following features.

1. A foaming system comprising:
a plurality of foaming means for foaming surface active agent solution;
a foamed liquid supply means for supplying said surface active agent solution foamed by said plurality of foaming means to a supply object;
a surface active agent supply means for supplying said surface active agent solution to said plurality of foaming means;
a gas supply means for supplying gas to said plurality of foaming means; and
a water supply means for supplying water to said supply object, wherein
said foamed liquid supply means has a plurality of pipe-like members provided corresponding to said plurality of foaming means.

2. The foaming system according to above 1. wherein said surface active agent supply means has a surface active agent supply pipe which communicates with said plurality of foaming means, said gas supply means has a gas supply pipe which communicates with said plurality of foaming means and said water supply means has a water supply pipe.

3. The foaming system according to above 2. wherein said water supply pipe communicates with said plurality of foaming means.

4. The foaming system according to above 3. wherein two or more of said surface active agent supply pipe, said gas supply pipe and said water supply pipe are used with the same pipes.

5. The foaming system according to above 1. wherein said water supply means comprises a first linkage path for linking said foaming means with a water supply source and an opening/closing valve provided in the midway of the first linkage path and said surface active agent supply means comprises a second linkage path for linking the downstream side of said opening/closing valve of said first linkage path with a surface active agent supply source and a sending means which is provided in the midway of the second linkage path and sends said surface active agent solution from said surface active agent supply source to said second linkage path, said foaming system further comprising a control means for, when the foamed surface active agent solution is supplied to the supply object, turning ON/OFF said opening/closing valve repeatedly and turning ON/OFF said sending means repeatedly.

6. The foaming system according to above 5. wherein a storage container for storing said surface active agent solution is provided in the midway of said first linkage path and in the downstream side of a linkage portion of said second linkage path.

7. The foaming system according to above 1. wherein said foaming means is a foaming device attachable to a pipe.

8. The foaming system according to above 1. wherein said pipe-like member is a division pipe extending in a horizontal direction.

9. The foaming system according to above 1. wherein a discharge means for discharging water left inside the foamed liquid supply means is provided on said foamed liquid supply means.

10. The foaming system according to above 1. which is used for cleaning the surface of at least one of the floor and the plinth of a room such as a galley.

11. A foaming system comprising:
a unit linkage body which is formed by linking a plurality of foaming units, wherein
said foaming unit has a foaming unit main body which is provided with a foaming portion for foaming surface active agent solution, a foamed liquid supply path which communicates with the foaming portion and is supplied with said surface active agent solution foamed by the foaming portion and a supply nozzle whose one end communicates with said foamed liquid supply path while the other end is open outward.

12. The foaming system according to above 11. wherein said foaming unit main body comprises a gas supply path which communicates with said foaming portion and is supplied with gas, a surface active agent supply path which communicates with said foaming portion and is supplied with the surface active agent solution, a water supply path for supplying water to a supply object and said foamed liquid supply path.

13. The foaming system according to above 11. wherein said foaming unit main body comprises a gas supply path which communicates with said foaming portion and is supplied with gas, a surface active agent supply path which communicates with said foaming portion and is supplied with the surface active agent solution, and said foamed liquid supply path, at least one of said gas supply path, said surface active agent supply path and said foamed liquid supply path being capable of being supplied with water.

14. The foaming system according to above 11. further comprising: a first linkage path for linking said foaming portion with a water supply source; an opening/closing valve provided in the midway of the first linkage path; a second linkage path for linking the downstream side of the opening/closing valve of the first linkage path with a surface active agent supply source; a sending means which is provided in the midway of the second linkage path and sends said surface active agent solution from said surface active agent supply source to the second linkage path; and a control means which, when the foamed surface active agent solution is supplied to the supply object, turns ON/OFF said opening/closing valve and turns ON/OFF said sending means repeatedly.

15. The foaming system according to above 14. wherein a storage container for storing said surface active agent solution is provided in the downstream side of the linkage portion of said second linkage path and in the midway of said first linkage path.

16. The foaming system according to above 12. wherein said foaming portion has a throttle portion at the linkage portion between said gas supply path and said surface active agent supply path.

17. The foaming system according to above 13. wherein said foaming portion has a throttle portion at the linkage portion between said gas supply path and said surface active agent supply path.

18. The foaming system according to above 12. wherein in said foaming units adjacent in said unit linkage body, said foamed liquid supply path is sectioned and said gas supply path and said surface active agent supply path are connected.

19. The foaming system according to above 13. wherein in said foaming units adjacent in said unit linkage body, said foamed liquid supply path is sectioned and said gas supply path and said surface active agent supply path are connected.

20. The foaming system according to above 12. wherein said gas supply path, said surface active agent supply path and said foamed liquid supply path are disposed in the linkage direction of said unit linkage body.

21. The foaming system according to above 13. wherein said gas supply path, said surface active agent supply path and said foamed liquid supply path are disposed in the linkage direction of said unit combined body.

22. The foaming system according to above 11. which is used for cleaning the surface of at least one of the floor and the plinth of a room such as a galley.

23. A foaming method using a foaming system including:
a plurality of foaming means for foaming surface active agent solution;
a foamed liquid supply means for supplying said surface active agent solution foamed by said plurality of foaming means to a supply object;
a surface active agent supply means for supplying said surface active agent solution to said plurality of foaming means;
a gas supply means for supplying gas to said plurality of foaming means; and
a water supply means for supplying water to said supply object, wherein
said foamed liquid supply means includes a plurality of pipe-like members corresponding to said plurality of foaming means, wherein
said foaming method comprising:
supplying said surface active agent solution and said gas to said foaming means with the surface active agent supply means and said gas supply means;
mixing the surface active agent solution with the gas with the foaming means to foam;
supplying the foamed surface active agent solution from said plurality of pipe-like members to said supply object; and
after left for a predetermined time, supplying water to said supply object with said water supply means.

24. The foaming method according to above 23. wherein said surface active agent supply means has a surface active agent supply pipe which communicates with said plurality of foaming means, said gas supply means has a gas supply pipe which communicates with said plurality of foaming means and said water supply means has a water supply pipe which communicates with the plurality of foaming means, said foaming method further comprising:
supplying said surface active agent solution to said surface active agent supply pipe while supplying said gas to said gas supply pipe;
mixing the surface active agent solution with the gas with said plurality of foaming means to foam;
supplying the foamed surface active agent solution to said supply object from said plurality of pipe-like member;
after left for a predetermined time, supplying water to said water supply pipe; and
supplying the water from said plurality of pipe-like members to said supply object through said plurality of foaming means.

25. The foaming method according to above 24. wherein when water is supplied to said water supply pipe, gas is supplied to said gas supply pipe.

26. A foaming method using a foaming system including:
a unit linkage body which is formed by linking a plurality of foaming units, wherein
said foaming unit has a foaming unit main body which is provided with a foaming portion for foaming surface active agent solution, a foamed liquid supply path which communicates with the foaming portion and is supplied with said surface active agent solution foamed by the foaming portion and a supply nozzle whose one end communicates with said foamed liquid supply path while the other end is open outward, wherein
said foaming method comprising, in said plurality of foaming units:
said surface active agent solution foamed by said foaming portion is supplied from said respective foamed liquid supply path to said supply object.

27. The foaming method according to above 26. wherein said foaming unit main body comprises a gas supply path which communicates with said foaming portion and is supplied with gas, a surface active agent supply path which communicates with said foaming portion and is supplied with the surface active agent solution, and said foamed liquid supply path, said surface active agent supply path being capable of being supplied with water,
said foaming method further comprising, in said foaming unit main body:
supplying said surface active agent solution to said surface active agent supply path while supplying gas to said gas supply path;
mixing the surface active agent solution with the gas in said foaming portion to foam;
supplying the foamed surface active agent solution to the supply object from said supply nozzle through said foamed liquid supply path;
after left for a predetermined time, supplying water to said surface active agent supply path; and
supplying the water to said supply object from said supply nozzles through said foaming portions and said foamed liquid supply path.

28. The foaming method according to above 27. wherein gas is supplied to said gas supply path when water is supplied to said surface active agent supply path.

According to the foaming system of the present invention, the surface active agent solution and gas are supplied to a plurality of foaming means with the surface active agent supply means and the gas supply means; the surface active agent solution is mixed with the gas with the foaming means and foamed; the foamed surface active agent solution is supplied from the plurality of pipe-like members to the supply object; and after the sprayed solution is left for a predetermined time, water is supplied to the supply object with the water supply means. Thus, the foamed surface active agent can be supplied uniformly to a supply object with an excellent foaming condition even if it is a relatively wide supply object. Further, the surface active agent supplied to the supply object can be washed away with water.

Because the surface active agent supply means has a surface active agent supply pipe which communicates with the plurality of foaming means, the gas supply means has a gas supply pipe which communicates with the plurality of foaming means and the water supply means has a water supply pipe, a simple and cheap structure can be achieved.

Because the water supply pipe communicates with the plurality of foaming means, the surface active agent solution left inside the plurality of foaming means can be washed away thereby keeping the system clean.

Further, because two or more of the surface active agent supply pipe, the gas supply pipe and the water supply pipe are used with the same pipes, a simpler and cheaper structure can be attained.

Because the water supply means comprises a first linkage path and an opening/closing valve and the surface active agent supply means comprises a second linkage path and a sending means and further comprises a control means, the dilution water amount and dilution ratio of the surface active agent solution can be changed easily without any complicated adjustment work. Additionally, the entire system comes to have a cheap and simple structure.

Because a storage container for storing the surface active agent solution is provided in the midway of the first linkage path and in the downstream of a linkage portion of the second linkage path, unevenness in the dilution water amount and dilution ratio of the surface active agent solution can be reduced even if the repeat number of ON/OFF of the opening/closing valve and sending means is decreased within a reasonable range. Consequently, the service lives of the opening/closing valve and sending means can be extended.

Further, because the foaming means is a foaming device attachable to a pipe, a simpler and cheaper structure can be attained.

Because the pipe-like member is a division pipe extending in a horizontal direction, the division pipe can be disposed avoiding an entrance and exit of a room and its construction can be achieved easily at a low cost.

Because a discharge means for discharging water left inside the foamed liquid supply means is provided on the foamed liquid supply means, water left in the foamed liquid supply means can be discharged substantially completely and the surface active agent supplied to this foamed liquid supply means can be changed to an excellent foaming condition without dilution.

Further, if this system is used for cleaning the surface of at least one of the floor and the plinth, the interior of a room such as a galley can be cleaned favorably.

Because according to other foaming system of the present invention, surface active agent solution foamed by each of the plurality of foaming units is supplied from each foamed liquid supply path in a plurality of foaming units to a supply object, the foamed surface active agent solution can be supplied uniformly to the supply object with an excellent foaming condition even if it is a relatively wide supply object.

Further, because the foaming unit main body includes a gas supply path, a surface active agent supply path, a water supply path and a foamed liquid supply path, the surface active agent solution can be mixed with gas and foamed through the surface active agent supply path and gas supply path by foaming portions in a plurality of foaming units, efficiently and favorably. Additionally, after the foamed surface active agent solution is supplied and left for a predetermined time, it can be washed away by supplying water to the supply object through the water supply path.

Further because the foaming unit main body includes the gas supply path, the surface active agent supply path and the foamed liquid supply path while at least one of these can be supplied with water, the foaming portion of each of the plurality of foaming units is capable of mixing the surface active agent solution with gas to foam through the surface active agent supply path and the gas supply path, effectively and favorably. Additionally, after the foamed surface active agent solution is supplied and left for a predetermined time, the surface active agent solution can be washed away by supplying water to at least one of those supply paths. Still further, the system can be protected from mildew, deposit and other deterioration and kept clean by washing away surface active agent solution remaining inside the foaming portion and each path with water.

Because the system of the present invention comprises a first linkage path, an opening/closing valve, a second linkage path, a sending means and a control means, the dilution water amount, dilution ratio and the like of the surface active agent solution can be changed easily without any complicated adjustment work. Further, the entire system can be constructed with a cheap and simple structure.

Because the storage container for storing the surface active agent is provided in the midway of the first linkage path and on the downstream side of the linkage portion of the second linkage path, unevenness in the dilution water amount and the dilution ratio of the surface active agent solution can be reduced even if the repeat number of the ON/OFF control of the opening/closing valve and sending means is reduced within a reasonable range. Consequently, the service lives of the opening/closing valve and sending means can be expanded.

Because the foaming portion has a throttle portion at the linkage portion between the gas supply path and the surface active agent supply path, even if the interval between the front end of the main body (supply source) and the foaming unit is extended, the surface active agent solution, gas, water and foamed liquid are distributed equally to the foamed liquid supply paths of each foaming unit. Consequently, this system is capable of corresponding to a wider supply object.

Because in the foaming units adjacent in the unit combined body, the foamed liquid supply path is sectioned and the gas supply path and the surface active agent supply path are connected, this system is capable of corresponding to a wider supply object.

Because the gas supply path, the surface active agent supply path and the foamed liquid supply path are disposed in the linkage direction of the unit combined body, the system can be constructed with a simple and cheap structure.

Further, if this system is used for cleaning the surface of at least one of the floor and plinth of a room such as a galley, it can be cleaned favorably.

According to the foaming method of the present invention, the surface active agent solution and gas are supplied to the foaming means with the surface active agent supply means and the gas supply means; the surface active agent solution is mixed with the gas with the foaming means and foamed; the foamed surface active agent solution is supplied from the plurality of pipe-like members to the supply object; and after left for a predetermined time, water is supplied to the supply object with the water supply means. Consequently, the foamed surface active agent can be supplied uniformly to the supply object with an excellent foaming condition even if it is a relatively wide supply object. Additionally, the surface active agent supplied to the supply object can be washed away with water.

Further, the surface active agent supply means has a surface active agent supply pipe which communicates with the plurality of foaming means, the gas supply means has a gas supply pipe which communicates with the plurality of foaming means and the water supply means has a water supply pipe which communicates with the plurality of foaming means. With this condition, the surface active agent solution is supplied to the surface active agent supply pipe while the gas is supplied to the gas supply pipe; the surface active agent solution is mixed with the gas with the plurality of foaming means and foamed; the foamed surface active agent solution is supplied to the supply object from the plurality of pipe-like member; after left for a predetermined time, water is supplied to the water supply pipe; and the water is supplied from the plurality of pipe-like members to the supply object through the plurality of foaming means. Consequently, this system is capable of corresponding to a relatively wide supply object and supplying the foamed surface active agent solution while it is also capable of washing away the supplied surface active agent with water. Further, it is capable of washing away the surface active agent solution left in the foaming means and each pipe with water to protect the system from mildew, deposit and other deterioration and keep it clean.

Because when water is supplied to the water supply pipe, gas is supplied to the gas supply pipe, water is distributed equally through each pipe-like member, water pressure is increased, so that its washing force is increased.

Because according to the foaming method of the present invention, the surface active agent foamed in each foaming portion is supplied from each foamed liquid supply path to the supply object in the plurality of foaming units, the foamed surface active agent solution can be supplied equally to the supply object with an excellent foaming condition even if it is a relatively wide supply object.

Further, because the gas supply path communicating with the foaming portion and supplied with gas, the surface active agent supply path communicating with the foaming portion and supplied with the surface active agent solution, and the foamed liquid supply path are provided in the foaming unit main body, while the surface active agent supply path can be supplied with water, the gas and the surface active agent solution are mixed in the foaming portion in each foaming unit, the foamed surface active agent solution is supplied from the supply nozzle to the supply object through the foamed liquid supply path. After left for a predetermined time, the surface active agent supply path is supplied with water and that water is supplied from the supply nozzle to the supply object through the foaming portion and foamed liquid supply path so as to wash away the surface active agent. Further, the surface active agent solution left inside the foaming portion and each path can be washed away to protect the system from mildew, deposit and other deterioration and keep it clean.

Because when water is supplied to the surface active agent supply path, gas is supplied to the gas supply path, water is distributed equally to each foaming unit, so that water pressure is increased and its washing performance is intensified.

### BRIEF DESCRIPTION OF THE DRAWINGS

FIG. 1 is a perspective view showing the entire structure of a floor surface cleaning system of a first embodiment;

FIG. 2 is a sectional view of the floor surface cleaning system shown in FIG. 1;

FIG. 3 is a sectional view for explaining the foaming device;

FIG. 4 is a block diagram for explaining respective supply means;

FIG. 5 is a sectional view of a T-type joint;

FIG. 6 is a perspective view of a division pipe;

FIG. 7 is an explanatory diagram for explaining other formation of the foamed liquid supply means;

FIG. 8 is an explanatory diagram for explaining further other formation of the foamed liquid supply means while FIG. 8(a) shows a formation constructed with front end portions of the vertical pipe and FIG. 8(b) shows the formation constructed with branch supply members;

FIG. 9 is a development diagram for explaining other formation of the floor surface cleaning system;

FIG. 10 is a development diagram for explaining other formation of the floor surface cleaning system;

FIG. 11 is a development diagram for explaining other formation of the floor surface cleaning system;

FIG. 12 is a perspective view showing the entire structure of the floor surface cleaning system according to a second embodiment;

FIG. 13 is a sectional view of the foaming block and passage block of the foaming device not connected;

FIG. 14 is a sectional view of the foaming block and passage block of the foaming device connected;

FIG. 15 is a sectional view taken along the line XV-XV in FIG. 13;

FIG. 16 is a sectional view taken along the line XVI-XVI in FIG. 13;

FIG. 17 is a sectional view for explaining other formation of the foaming system;

FIG. 18 is a perspective view showing the entire structure of the floor surface cleaning system according to a third embodiment;

FIG. 19 is a sectional view of the foaming block and passage block of the foaming device not connected;

FIG. 20 is a sectional view of the foaming block and passage block of the foaming device connected;

FIG. 21 is a sectional view taken along the XXXI-XXXI in FIG. 19;

FIG. 22 is a sectional view taken along the XXII-XXII in FIG. 19;

FIG. 23 is a sectional view for explaining other example of the foaming device;

FIG. 24 is an explanatory diagram for explaining the operation of the foaming device according to the third embodiment;

FIG. 25 is an explanatory diagram for explaining the operation of other example of the foaming device;

FIG. 26 is an explanatory diagram for explaining the supply system of cleaning liquid and water;

FIG. 27 is an explanatory diagram for explaining the supply system of cleaning liquid and water;

FIG. 28 is an explanatory diagram for explaining other supply system of cleaning liquid and water;

FIG. 29 is an explanatory diagram for explaining other supply system of cleaning liquid and water;

FIG. 30 is an explanatory diagram for explaining further other supply system of cleaning liquid and water; and

FIG. 31 is an explanatory diagram for explaining further other supply system of cleaning liquid and water.

### DETAILED DESCRIPTION OF THE INVENTION

First Embodiment

<Foaming System>

The foaming system of the first embodiment comprises the foaming means, foamed liquid supply means, surface active agent supply means, gas supply means and water supply means, which will be described successively below. The present invention does not specify any particular structure, scale, supply object and the like of this foaming system. In the meantime, the aforementioned supply object can be, for example, the surface of at least one of the interior floor and plinth of a galley.

The structure, shape, size and the like of the aforementioned foaming means are not specified to any particular one as long as it is capable of foaming surface active agent solution. This foaming means can include for example, a foaming device main body and a foaming body provided inside the foaming device main body. As the foaming body, for example, net-like body (metal net and the like), bound body (scrub and the like), cotton-like body (steel wool, glass wool and the like), porous body (sponge, porous filter and the like) can be mentioned. Further, a plurality of pieces of the net-like body can be disposed in parallel at a predetermined interval along the axis inside a cylindrical foaming device main body. Consequently, it is possible to provide a foaming device having a cheap and simple structure capable of foaming effectively and excellently. Further, to facilitate cleaning and replacement of the net-like body, it is preferable that the foaming device main body can be disassembled/reassembled. Further, from viewpoint for foaming effectively and excellently, the net-like body is preferred to be in 40-100 mesh, particularly more preferably 60-80 mesh. Further, preferably, the quantity of set net-like bodies is 1-20 pieces, particularly 3-8 pieces. The net-like body is preferred to be formed in a bellow type. Further, from viewpoints for improving corrosion protection, preferably, the foaming device main body is made of synthetic resin, stainless or the like. Further, from viewpoint for preventing mildew, preferably, this foaming device main body is made of material containing mildew proof agent. This foaming device main body can be attached to the pipe or the like.

A downstream side foaming means may be provided in the downstream of this foaming means. Consequently, surface active agent solution whose foaming is completed can be foamed again. As a result, a wider supply object can be covered. This downstream foaming means can be structured in the same structure as the above-described foaming device. Further, a passage switching means (for example valve or the like) for switching the passage may be provided in the upstream of this foaming means. Consequently, the surface active agent solution can be supplied to a plurality of foaming means successively in a predetermined order. As a result, a wider supply object can be covered.

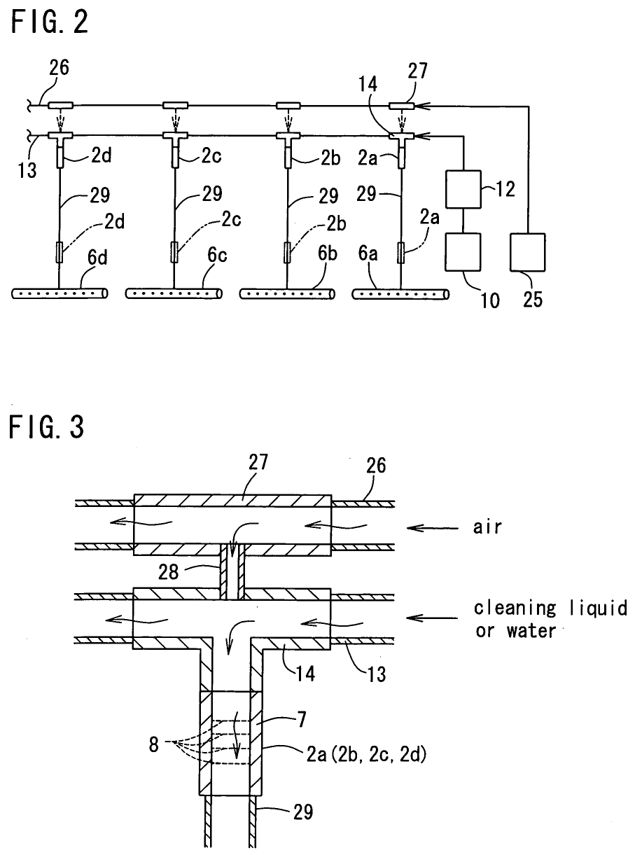

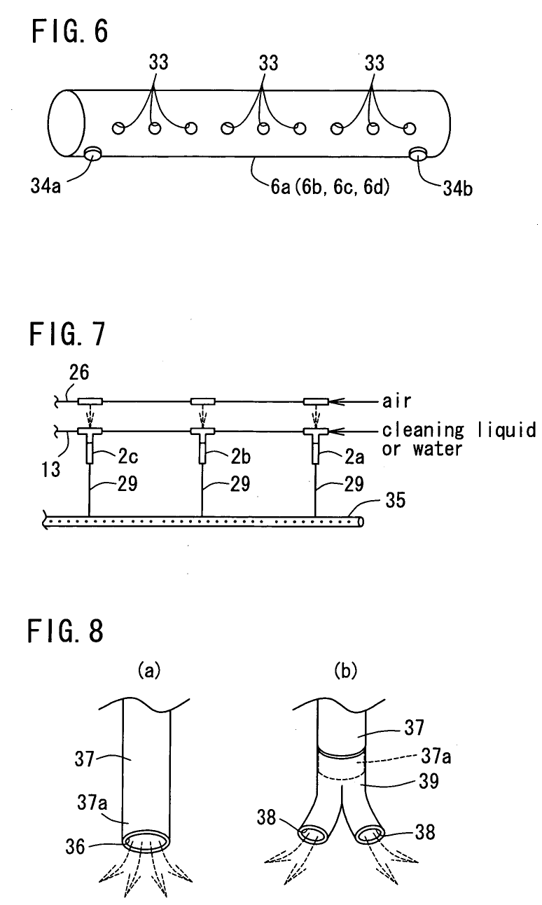

The structure, shape, quantity and the like of the foamed liquid supply means are not specified to any particular one as long as it is capable of supplying the surface active agent solution foamed by the foaming means to a supply object. This foamed liquid supply means has a plurality of pipe-like members provided corresponding to a plurality of pieces of the foaming means. As this pipe-like member, for example, the division pipe (see FIGS. 2, 6) extending in the horizontal direction, an open end portion (see FIG. 8) of a pipe extending in the vertical direction and the like can be mentioned. Usually, this foamed liquid supply means has a supply port for supplying foamed surface active agent solution to a supply object. This foamed liquid supply means is disposed so as to surround the supply object at the bottom portion of the supply object (for example, interior floor surface, plinth surface and the like). Preferably, this foamed liquid supply means is constituted of synthetic resin, stainless or the like for the reason that it is capable of improving corrosion resistance. This foamed liquid supply means is preferred to be composed of material containing mildew proof agent.

The shape, size, quantity, length and the like of the division pipes are not restricted to any particular one. Usually, this division pipe is disposed along the horizontal direction. Further, as the contour shape of this division pipe, for example, linear, curved, bent shapes and the like can be mentioned. Further, as the sectional shape of this division pipe, for example, round, angular, irregular ring shapes and the like can be mentioned. Further, this division pipe may be provided with a plurality of supply ports at a specified interval along the axial direction.

The plurality of division pipes may be of the same structure and shape or pipes having different structure and shape can be combined.

The foamed liquid supply means can be provided with, for example, a discharge means (for example, drain valve) for discharging water left in the foamed liquid supply means. Consequently, water left in the foamed liquid supply means can be discharged completely, so that the surface active agent solution supplied into the inside of the foamed liquid supply means is not diluted, but the surface active agent solution in an excellent foaming condition can be supplied to a supply object.

The structure, configuration and the like of the surface active agent supply means are not restricted to any particular one as long as it is capable of supplying surface active agent solution to a plurality of foaming means. This surface active agent supply means can contain, for example, an accommodation container for accommodating surface active agent solution, a pipe for connecting this accommodation container to a plurality of foaming means and a sending means (for example, pump) provided on this pipe. This pipe can be disposed so that it surrounds a supply object at an upper portion (for example, room ceiling, plinth surface near ceiling and the like) of the supply object. This surface active agent supply means mixes surface active agent solution with gas (for example, air, nitrogen gas, carbon dioxide gas) to foam preliminarily and supply to a plurality of foaming means with that foamed condition (or containing bubbles). Consequently, the surface active agent solution can be foamed effectively so as to obtain an excellent foaming condition.

Further, the surface active agent supply means comprises a diluting portion (for example, joint pipe) for mixing the surface active agent solution with water to dilute. As a result, surface active agent solution diluted sufficiently by the diluting portion can be supplied to a plurality of foaming means, so that the cleaning liquid can be foamed effectively to obtain an excellent foaming condition. This diluting portion comprises, for example, a flow intake through which water flows in, a flow intake through which the surface active agent solution flows in and a joint having a flow outlet continuous from these flow intakes. Preferably, the both flow intakes are provided with a flow amount adjusting means (for example, flow amount adjusting chip, cock) to dilute effectively.

The structure, configuration and the like of the gas supply means are not restricted to any particular one as long as it is capable of supplying gas (for example, air, nitrogen gas, carbon dioxide gas) to a plurality of foaming means. This gas supplying means comprises for example, a pipe continuous from the plurality of foaming means and a sending means (for example, blower, compressor) provided on this pipe. This pipe can be disposed so as to surround a supply object at an upper portion (for example, room ceiling, plinth surface near the ceiling) of the supply object.

The structure, configuration and the like of the water supply means are not restricted to any particular one as long as it is capable of supplying water (for example, tap water) to the supply object. This water supply means is capable of supplying water directly to the supply object. Further, this water supply means is capable of supplying water to the supply object through the foaming means and foamed liquid supply means. Consequently, surface active agent solution left in the plurality of foaming means and foamed liquid supply means can be washed away and consequently, the same apparatus can be kept clean.

This water supply means comprises for example, a pipe continuous from a water supply source (for example, cock of tap water) and a flow amount adjusting means (for example, flow amount adjusting valve) provided on this pipe. Further, this water supply means includes for example, an accommodation container for accommodating water, a pipe continuous to this accommodating container and a sending means (for example, pump) provided on this pipe. This pipe is provided so as to surround the supply object at an upper portion (for example, room ceiling, plinth surface near the ceiling) of the supply object.

It is preferable to use elements constituting the surface active agent supply means, the gas supply means and water supply means commonly in order to provide a cheap and simple structure system. More specifically, (1) two or more pipes of the surface active agent supply means, gas supply means and water supply means are substituted by a common pipe and (2) two or more sending means of the surface active agent supply means, gas supply means and water supply means are substituted by a common sending means. The above-mentioned types (1) and (2) can be combined. Further, the above-mentioned pipes can be partly or all constructed of common pipes.

Particularly, as described in embodiments which will be stated later, preferably, the liquid supply pipe used for both the surface active agent supply means and water supply means and the gas supply pipe constituting the gas supply passage are provided so as to surround a supply object at the upper portion of the supply object. In this case, the foaming means may be attached to a plurality of specified locations along the length direction of the liquid supply pipe. Consequently, it is possible to provide a system easy to constructed with a simple and cheap structure.

Preferably, the pipes included in the surface active agent supply means, gas supply means and water supply means are made of synthetic resin, stainless or the like in order to improve anti-corrosion property. Further, preferably, the pipes of the surface active agent supply means, gas supply means and water supply means are composed of material containing mildew proof agent in order to protect from mildew.

The foaming system can comprise, for example, a sending means of the surface active agent supply means, gas supply means and water supply means and a control means for controlling flow amount adjusting means and the like.

The required dilution amount of the surface active agent solution is usually 1/100-1/200 depending on the contamination by oil or the like. The dilution amount of this surface active agent solution is proportional to a foaming area. On the other hand, when washing, a predetermined amount of water is required and generally, the larger the diameter, the better washing result can be obtained.

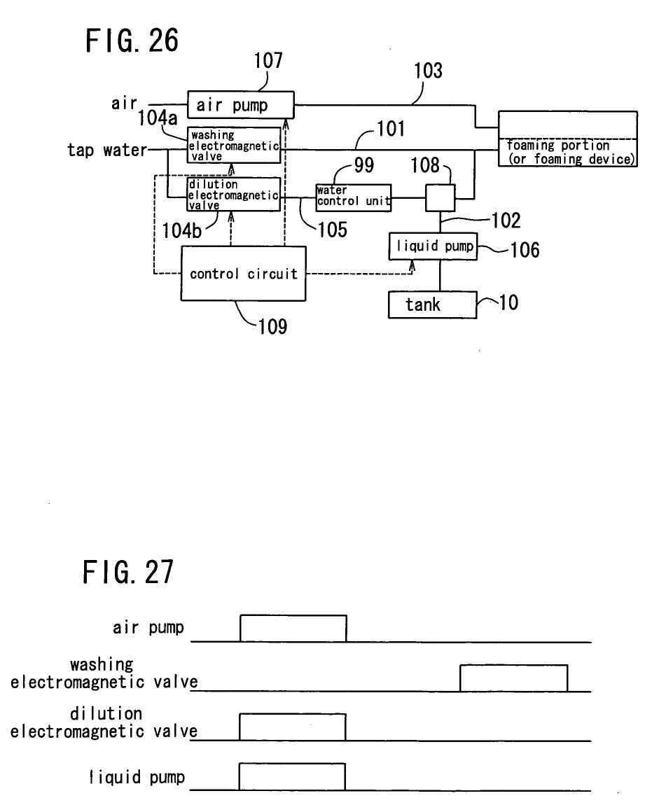

As shown in FIGS. 26 and 27, the water supply means comprises a first linkage path 101 for linking the foaming means and the water supply source with a washing opening/closing valve 104a provided in the midway of the first linkage path. The surface active agent supply means comprises a bypass route 105 for connecting the upstream side and the downstream side of the washing opening/closing valve in the first linkage path, dilution opening/closing valves 101b and water control unit 99 provided on the bypass route, a second linkage path 102 for linking the downstream side of the water control unit in the bypass route with the surface active agent supply source, and a sending means 106 which is provided in the midway of the second linkage path for sending the surface active agent solution from the surface active agent supply source to the second linkage path. This surface active agent supply means may further comprise a control means 109 which turns OFF the washing opening/closing valve while turning ON the dilution opening/closing valve and the sending means when the surface active agent solution is supplied to the supply object.

The structure and configuration of the water supply source are not specified to any particular one. As this water supply source, for example, a cock for tap water, water storage tank and the like can be mentioned.

The first linkage path, second linkage path and bypass route are not specified to any kind, installation condition and the like. As the first linkage path, second linkage path and bypass route, for example, a linkage pipe (including a tube), a linkage path and the like can be mentioned.

The structure and installation condition of the washing opening/closing valve and dilution opening/closing valve are not specified to any particular one. As the opening/closing valve, for example, an electromagnetic valve can be mentioned.

The structure and installation condition of the sending means are not specified to any particular one. As this sending means, for example, a pump or the like can be mentioned.

The structure and installation condition of the control means are not specified to any particular one. Usually, this control means comprises CPU, ROM, RAM and the like. When supplying water to a supply object, this control means turns ON the washing opening/closing valve 104a while turning OFF the dilution opening/closing valve 104b and the sending means 106.

The above-described structure can be applied to following system also.

In the above embodiment, it is necessary to adjust a site depending on the foaming area by replacing the water control unit or changing the discharge size of the sending means corresponding to the quantity, size and the like of the foaming means (for example, foaming device). Therefore, the entire system is relatively expensive and has a complicated structure because the replacement work for the water control unit and sending means is complicated and part installation positions are specified.

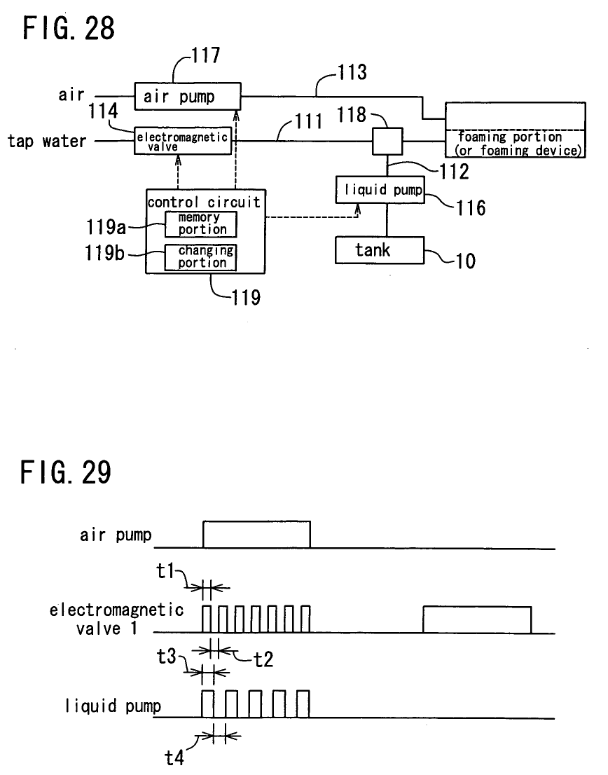

According to an embodiment for solving the above-described problem, as shown in FIGS. 28 and 29, the water supply means comprises a first linkage path 111 for linking the foaming means with the water supply source and an opening/closing valve 114 provided in the midway of the first linkage path. The surface active agent supply means comprises a second linkage path 112 for linking the downstream side of the opening/closing valve in the first linkage path with a sending means 116 which is provided in the midway of the second linkage path for sending the surface active agent solution from the surface active agent supply source to the second linkage path. This surface active agent supply means may further comprise a control means 119 which turns ON/OFF the opening/closing valve while turning ON/OFF the sending means when the surface active agent solution is supplied to the supply object. Consequently, the above-described dilution opening/closing valve and the water control unit can be omitted thereby the entire system being constructed into a cheap and simple structure. Further, by changing the ratio t1/t2 between the ON time t1 and the OFF time t2 of the opening/closing valve and the ratio t3/t4 between the ON time t3 and OFF time t4 of the sending means, the dilution amount, dilution ratio and the like of the surface active agent solution can be adjusted.

The structure and installation condition of the opening/closing valve are not specified to any particular one. As this opening/closing valve, for example, an electromagnetic valve can be mentioned.

The structure and installation condition of the control means are not specified to any particular one. Usually, this control means comprises CPU, ROM, RAM and the like. When supplying, for example, water to a supply object, this control means turns ON the opening/closing valve or repeats ON/OFF thereof in a predetermined time interval while turning OFF the sending means. The control means can comprises one or two or more of (1) a ratio changing means for changing the ratio between ON time and OFF time of the opening/closing valve and the ratio between the ON time and OFF time of the sending means, (2) a time changing means for changing the ON time/OFF time of the opening/closing valve and the ON time/OFF time of the sending means and (3) a repetitive number changing means for changing the repetitive number of the ON/OFF of the opening/closing valve and the repetitive number of the ON/OFF of the sending means. Consequently, the dilution amount, dilution ratio and the like of the surface active agent solution can be adjusted easily.

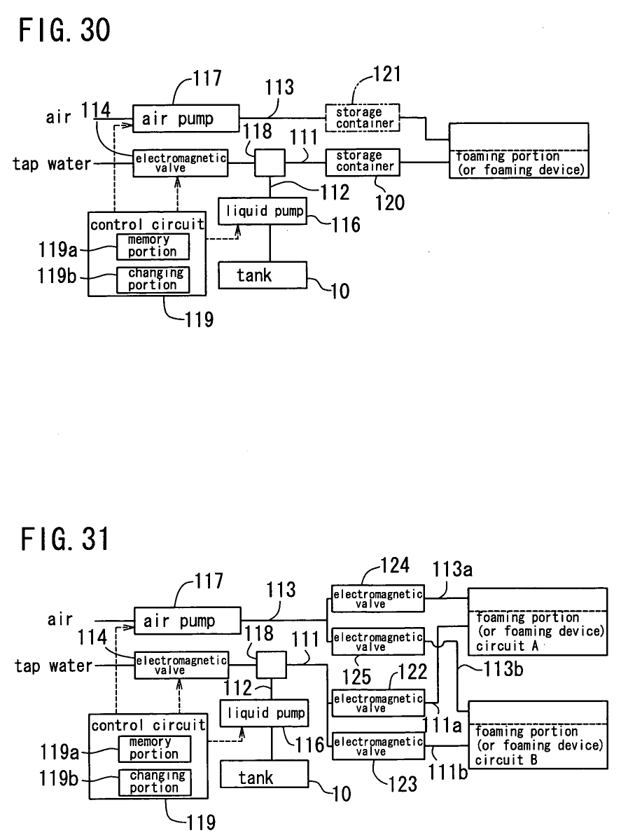

According to the above embodiment, as shown in FIG. 30, a storage container 120 for storing the surface active agent solution may be provided in the midway of the first linkage path 111 and on the downstream side of a joint portion with the second linkage path 112. The gas supply means may includes a third linkage path 113 for linking the foaming means with a sending means 117 for sending gas to the foaming means and a storage container 121 for storing gas may be provided in midway of the third linkage path.

The structure, size and shape of the storage container are not specified to any particular one. This storage container may be a pipe, path or the like having a sectional area larger than the first linkage path and the third linkage path. The structure and installation condition of the sending means are not specified to any particular one. As this sending means, for example, a pump and blower can be mentioned.

The control means is capable of, for example when supplying water to a supply object, turn ON the opening/closing valve or repeat ON/OFF of the same valve, then turns OFF the sending means and further turn ON the gas sending means for supplying gas to the foaming means or repeat ON/OFF of the same means. Consequently, water is distributed equally to a plurality of foaming means so that water pressure is increased thereby intensifying washing force. As this gas sending means, for example, a pump, a blower or the like can be mentioned.

The aforementioned surface active agent is not restricted to any particular type as long as it can be foamed in water. This surface active agent can be used in liquid state or in a condition in which it is diffused in water and its density is preferred to be 0.1 weight % or more although it is not restricted to any particular value. If the density is kept over 0.1 weight %, when the aforementioned surface active agent is foamed, that foaming state can be maintained sufficiently.

As the surface active agent, for example, glycerol fatty acid ester, saccharose fatty acid ester, polyoxyethylene fatty acid ester, polyoxypropylene fatty acid ester, sodium polyoxy oleate, polyoxyethylene mono alkyl ester, alkylamine oxy ethylene additive and the like can be mentioned. It is permissible to use one or two kinds of these at the same time.

The aforementioned glycerol fatty acid ester is not restricted to any particular one as long as it has a surface activity operation. This fatty acid means high grade fatty acid and usually, the one whose quantity of carbons is 8-20 is used. As the glycerol fatty acid ester, glycerol mono stearate, glycerol mono oleate, deca glycerol mono oleate, glycerol acetate fatty acid ester, glycerol lactate fatty acid ester, glycerol citrate fatty acid ester, glycerol succinate fatty acid ester, glycerol diacetyl tartrate fatty acid ester, glycerol acetate ester and the like can be mentioned. Of these, the deca glycerol mono oleate is preferably used. Further, the saccharose fatty acid ester is not restricted to any particular one as long as it has surface activity and this fatty acid means high grade fatty acid and usually, the one whose quantity of carbons is 8-20 is used. Further, as this ester, mono ester, di-ester, tri-ester and the like can be mentioned and of these, mono-ester and di-ester are preferably used. The alkyl of the polyoxyethylene mono alkyl ester is not restricted to any particular one however, the alkyl whose quantity of carbons is 10-18 is used

<Foaming Method>

The foaming method according to the first embodiment is a foaming method employing the foaming system of the first embodiment. According to this method, the surface active agent solution and gas are supplied to a plurality of foaming means by the surface active agent solution supply means and the gas supply means. The surface active agent and the gas are mixed by each of the foaming means so as to foam the solution. The foamed surface active agent solution is supplied to the supply object through the plurality of pipe-like members. After left for a predetermined time, water is supplied to the supply object by the water supply means. According to this foaming method, for example, the surface active agent supply means contains a surface active agent supply pipe connected to the plurality of foaming means, the gas supply means contains a gas supply pipe connected to the plurality of foaming means and the water supply means contains a water supply pipe connected to the plurality of foaming means. The surface active agent solution is supplied to the surface active agent supply pipe and the gas is supplied to the gas supply pipe and then, the surface active agent solution and the gas are mixed by the plurality of foaming means. The foamed surface active agent solution is supplied from the plurality of pipe-like members to the supply object. After left for a predetermined time, water is supplied to the water supply pipe and that water is supplied from the plurality of pipe-like members to the supply object through the plurality of foaming means.

This foaming method enables gas to be supplied to the gas supply pipe when water is supplied to the water supply pipe.

Further, this foaming method enables, when the foamed surface active agent is supplied to the supply object, the opening/closing valve to be turned ON/OFF for a predetermined time while the sending means to be turned ON/OFF and further when water is supplied to the supply object, the opening/closing valve to be turned ON or repeatedly turned ON/OFF while the sending means to be turned OFF. In this case, when supplying water to the supply object, the gas sending means for supplying gas to the foaming means is turned ON or repeatedly turned ON/OFF. As this gas sending means, for example, a pump, a blower and the like can be mentioned. Second embodiment

<Foaming System>

The structure, scale, supply object and the like of the foaming system according to the second embodiment are not specified to any particular one as long as it includes a unit linkage body in which a plurality of foaming devices are combined. This unit linkage body can be disposed at a lower portion (for example, floor surface of a room, plinth surface and the like) of the supply object so that it surrounds the supply object. Description of components having the same structure as the first embodiment is omitted.

The structure, configuration, material and the like of the foaming device are not specified to any particular one as long as the foaming portion, foamed liquid supply path and supply nozzle which will be described below are provided in the foaming device main body. In this foaming device main body, usually, paths for supplying gas, surface active agent solution and water are formed. Preferably, the foaming device main body is composed of synthetic resin, stainless or the like in order to improve anti-corrosion property. Further, this foaming device main body is composed of material containing mildew proof agent in order to protect from mildew. This foaming device main body can be constituted of a path block and a foaming block, which are separable. In this case, that path block can be provided with various kinds of paths and the foaming block can be provided with various kinds of paths, which will be described later, a foaming portion, a linking portion for linking the path with the foaming portion and a sectioning portion for sectioning the foamed liquid supply paths in adjacent foaming blocks.

The structure, configuration, size and the like of the foaming portion are not specified to any particular one as long as it is capable of foaming surface active agent solution. Usually, this foaming portion is so constructed that a foaming body is provided in the foaming path. As this foaming body, for example, net-like body (metal net or the like), bound body (scrub or the like), cotton-like body (steel wool, glass wool or the like), porous body (sponge, porous filter or the like) can be mentioned. The net-like bodies can be arranged at a specified interval along the axis direction inside of the foaming path. As this net-like body, for example, the one described in the first embodiment can be applied.

This foaming portion may have a throttle portion at a linkage portion between a gas supply path and a surface active agent supply path, which will be described later. Consequently, the surface active agent solution, gas, water and foamed liquid are distributed equally to the foamed liquid supply paths in the foaming device, in order to correspond to a wider supply object. The throttle portion is a mixture passage portion in which for example, gas and surface active agent solution pass mixedly. The throttle portion means a portion having a smaller sectional area than a gas supply path which will be described later and the surface active agent supply path.

The structure, configuration, length and the like of the foamed liquid supply path are not specified to any particular one as long as it is continued from the foaming portion and supplied with surface active agent solution foamed by the foaming portion.

The structure, configuration, length and the like of the supply nozzle are not specified to any particular one as long as an end thereof is continued to the foamed liquid supply path and the other end thereof is open outward. The supply nozzles can be provided along the length direction of the foamed liquid supply path in a large quantity. As this supply nozzle, for example, a supply port formed in the foaming device main body, a supply pipe attached to the foaming device main body and the like can be mentioned.

As the path formation examples of the foaming device, for example, examples (1)-(3), which will be shown below, can be mentioned.

(1) The foaming device main body being provided with the gas supply path which is continued from the foaming portion for supplying gas, the surface active agent supply path which is continued from the foaming portion for supplying the surface active agent solution, water supply path for supplying water and the foamed liquid supply path.

(2) The foaming device being provided with the gas supply path which is continued from the foaming portion for supplying gas, the surface active agent supply path which is continued to the foaming portion for supplying the surface active agent solution and the foamed liquid supply portion, while at least one of the gas supply path, the surface active agent supply path and the foamed liquid supply path being supplied with water.

(3) The foaming device main body being provided with the surface active agent supply path which is continued from the foaming portion for supplying surface active agent solution mixed with gas and the foamed liquid supply path, while at least one of the surface active agent supply path and the foamed liquid supply path being supplied with water.

According to the example (1), the water supply path can be an independent path which is not linked with the foaming portion. In this case, usually, the foaming device is provided with a supply nozzle (for example, supply hole, supply pipe and the like) which is connected to the water supply portion at one end while the other side is open outward. The examples (2), (3) are preferred to be so constructed to be capable of supplying water to the surface active agent supply path in order to prevent generation of mildew, deposit or the like. Particularly, according to the example (2), when washing, it is preferable to supply water to the surface active agent supply path and gas to the gas supply path. The reason is that water is distributed equally by each foaming device so that water pressure is increased, thereby washing power being increased. According to the examples (1)-(3), the surface active agent supply path can be supplied with the surface active agent solution as a stock solution and dilution water at the same time.

To cope with a relatively wide supply object, according to the example (1), preferably, respective foamed liquid supply paths are sectioned and the gas supply path, the surface active agent supply path and the water supply path are linked with each other in adjacent foaming units of the unit linkage body. According to the example (2), preferably, respective foamed liquid supply paths are sectioned and the gas supply path and the surface active agent supply path are linked with each other. Further, according to the example (3), preferably, respective foamed liquid supply paths are sectioned while the respective surface active agent supply paths are linked with each other.

According to the example (1), to provide a simpler and cheaper system, preferably, the gas supply path, the surface active agent supply path, the foamed liquid supply path and the water supply path are arranged in parallel along the linkage direction of the unit linkage body. According to the example (2), preferably, the gas supply path, the surface active agent supply path and the foamed liquid supply path are arranged in parallel along the linkage direction of the unit linkage body. Further, according to the example (3), preferably, the surface active agent supply path and the foamed liquid supply path are arranged in parallel along the linkage direction of the unit linkage body.

When water is supplied from the foamed liquid supply path to a supply object like the examples (2), (3), it is preferable to provide a discharge means (for example, drainage valve) for discharging water left inside the foamed liquid supply path.

The dilution amount of the surface active agent solution needs to be 1/100-1/200 depending on contamination due to oil or the like. The dilution amount of this surface active agent solution is proportional to foaming area. On the other hand, when washing, a predetermined amount of water is necessary and generally, the large the diameter, the better washing result can be obtained.

As shown in FIGS. 26, 27, this system comprises a first linkage path 101 for linking the foaming portion with a water supply source, a washing opening/closing valve 104a provided in the midway of the first linkage path, a bypass route 105 for linking the upstream side of the washing opening/closing valve of the first linkage path with the downstream side, a dilution opening/closing valve 104b and water control unit 99 provided in the bypass route, a second linkage path 102 for linking the downstream side of the water control unit in the bypass route with the surface active agent supply source, a sending means 106 for sending the surface active agent solution from the surface active agent supply source provided in the midway of the second linkage path to the second linkage path and a control means 109 which when the foamed surface active agent solution is supplied to a supply object, turns OFF the washing opening/closing valve while turning ON the dilution opening/closing valve and the sending means.

The structure and installation condition of the water supply source are not specified to any particular one. As this water supply source, for example, a cock for tap water, a water storage tank and the like can be mentioned.

The kind and installation condition of the first linkage path, the second linkage path and bypass route are not specified to any particular one. As the first linkage path, the second linkage path and the bypass route, for example, a linkage pipe (including a tube), a linkage path and the like can be mentioned.

The structure and installation condition of the washing opening/closing valve and dilution opening/closing valve are not specified to any particular one. As these opening/closing valves, for example, an electromagnetic valve can be mentioned.

The structure and installation condition of the water control unit are not specified to any particular one. As this water control unit, for example, a flow amount adjusting valve can be mentioned.

The structure and installation condition of the control means are not specified to any particular one. Usually, this control means is comprised of CPU, ROM, RAM and the like. This control means is capable of, when supplying water to a supply object, turning ON the washing opening/closing valve while turning OFF the dilution opening/closing valve and sending means.

The above-described structure can be applied to a following example also.

In the above embodiment, it is necessary to adjust a site depending on the foaming area by replacing the water control unit or changing the discharge size of the sending means corresponding to the quantity, size and the like of the foaming portion. Therefore, the entire system is relatively expensive and has a complicated structure because the replacement work for the water control unit and sending means is complicated and part installation positions are specified.

According to an embodiment for solving the above-described problem, as shown in FIGS. 28, 29, this system comprises a first linkage path 111 for linking the foaming portion with a water supply source, a second linkage path 112 for linking the downstream side of the opening/closing valve in the first linkage path with a surface active agent supply source, a sending means 116 which is provided in the midway of the second linkage path for sending the surface active agent solution from the surface active agent supply source to the second linkage path and a control means 119 which turns ON/OFF the opening/closing valve in a predetermined time interval while turning ON/OFF the sending means when the formed surface active agent solution is supplied to the supply object. Consequently, the above-described dilution opening/closing valve and the water control unit can be omitted thereby the entire system being constructed into a cheap and simple structure. Further, by changing the ratio t1/t2 between the ON time t1 and the OFF time t2 of the opening/closing valve and the ratio t3/t4 between the ON time t3 and OFF time t4 of the sending means, the dilution amount, dilution ratio and the like of the surface active agent solution can be adjusted.

The structure and installation condition of the opening/closing valve are not specified to any particular one. As this opening/closing valve, for example, an electromagnetic valve can be mentioned.

The structure and installation condition of the control means are not specified to any particular one. Usually, this control means comprises CPU, ROM, RAM and the like. When supplying, for example, water to a supply object, this control means turns ON the opening/closing valve or repeats ON/OFF thereof in a predetermined time interval while turning OFF the sending means. The control means, for example, can comprise one or two or more of (1) a ratio changing means for changing the ratio between ON time and OFF time of the opening/closing valve and the ratio between the ON time and OFF time of the sending means, (2) an interval changing means for changing the ON time/OFF time of the opening/closing valve and the ON time/OFF time of the sending means and (3) a repetitive number changing means for changing the repetitive number of the ON/OFF of the opening/closing valve and the repetitive number of the ON/OFF of the sending means. Consequently, the dilution amount, dilution ratio and the like of the surface active agent solution can be adjusted easily.

According to the above embodiment, for example, as shown in FIG. 30, a storage container 120 for storing the surface active agent solution may be provided in the midway of the first linkage path 111 and on the downstream side of a linkage portion with the second linkage path 112. Further, it is possible to provide a third linkage path 113 for linking the foaming portion with a sending means 117 for sending gas to the foaming portion and a storage container 121 for storing gas in the midway of the third linkage path.

The structure, size and shape of the storage container are not specified to any particular one. This storage container, for example, may be a pipe, path or the like having a sectional area larger than the first linkage path and the third linkage path. The structure and installation condition of the sending means are not specified to any particular one. As this sending means, for example, a pump and blower can be mentioned.

The control means is capable of, for example when supplying water to a supply object, turn ON the opening/closing valve or repeat ON/OFF of the same valve, then turns OFF the sending means and further turn ON the gas sending means for supplying gas to the foaming portion or repeat ON/OFF of the same means. Consequently, water is distributed equally to a plurality of foaming portion so that water pressure is increased thereby intensifying washing force. As this gas sending means, for example, a pump, a blower or the like can be mentioned.

<Foaming Method>

The foaming method of the second embodiment is a foaming method using the foaming system according to the second embodiment. According to the same foaming method, the surface active agent solution is supplied to the foaming portion constituted of a plurality of foaming unit through the plurality of paths in the foaming unit and the surface active agent solution foamed by the foaming portion is supplied to a supply object.

According to this foaming method, the foaming unit main body, for example, is provided with the gas supply path which is connected to the foaming portion for supplying gas, the surface active agent supply path which is connected to the foaming portion for supplying surface active agent solution and the foamed liquid supply path while capable of supplying water to the surface active agent supply path. In each of the foaming units, the surface active agent solution is supplied to the surface active agent supply path and gas is supplied to the gas supply path. Then, the surface active agent solution and the gas are mixed in the foaming portion and the foamed surface active agent solution is supplied to a supply object from the supply nozzle through the foamed liquid supply path. Then, water is supplied to the surface active agent supply path after a predetermined time elapses and the water is supplied from the supply nozzle to the supply object through the foamed liquid supply path.

This foaming method enables gas to be supplied to the gas supply path when water is supplied to the surface active agent supply path.

Further, this foaming method enables, for example, when the foamed surface active agent solution is supplied to the supply object, the opening/closing valve to be turned ON/OFF for a predetermined time while the sending means to be repeatedly turned ON/OFF and further when water is supplied to the supply object, the opening/closing valve to be turned ON or repeatedly turned ON/OFF for a predetermined time while the sending means to be turned OFF. In this case, preferably, when supplying water to the supply object, the gas sending means for supplying gas to the foaming portion is turned ON or repeatedly turned ON/OFF. As this gas sending means, for example, a pump, a blower and the like can be mentioned.

### DESCRIPTION OF THE PREFERRED EMBODIMENT

Hereinafter, examples of the present invention will be described in detail with reference to the accompanying drawings. The examples of the foaming system described here is a floor surface cleaning system for supplying foamed cleaning liquid to the floor surface in a room which is a supply object.

### EXAMPLE 1

(1) Construction of Floor Surface Cleaning System

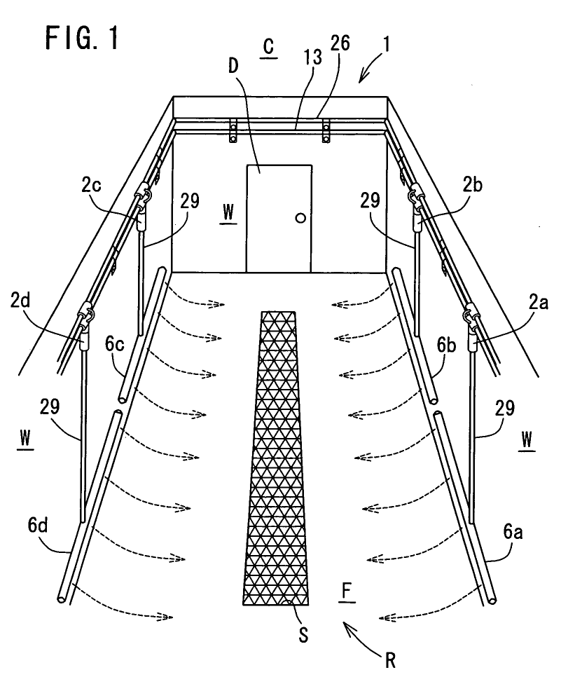

As shown in FIGS. 1, 2, the floor surface cleaning system of the example 1 comprises a plurality of foaming devices 2a-2d, a liquid supply pipe 13 which constitutes a liquid supply means 3 for supplying cleaning liquid and water to the respective foaming devices 2a-2d, air supply pipes 26 which constitutes an air supply means 4 for supplying air to the respective foaming devices 2a-2d and a plurality of division pipes 6a-6d made of synthetic resin to be connected to the downstream side of each foaming device 2.

As shown in FIG. 3, each of the foaming devices 2a-2d includes a synthetic resin made cylindrical foaming device main body 7 which can be disassembled and installed and a plurality of net-like bodies 8 of 80 mesh disposed in parallel with a predetermined interval within this foaming device main body 7. Each foaming device 2a-2d is attached to the bottom end portion of each T-shaped joint pipe 14 disposed in the midway of a liquid supply pipe 13. Each T-shaped joint pipe 14 is connected to each joint pipe 27 disposed in the midway of an air supply pipe 26 through a linking pipe 28.

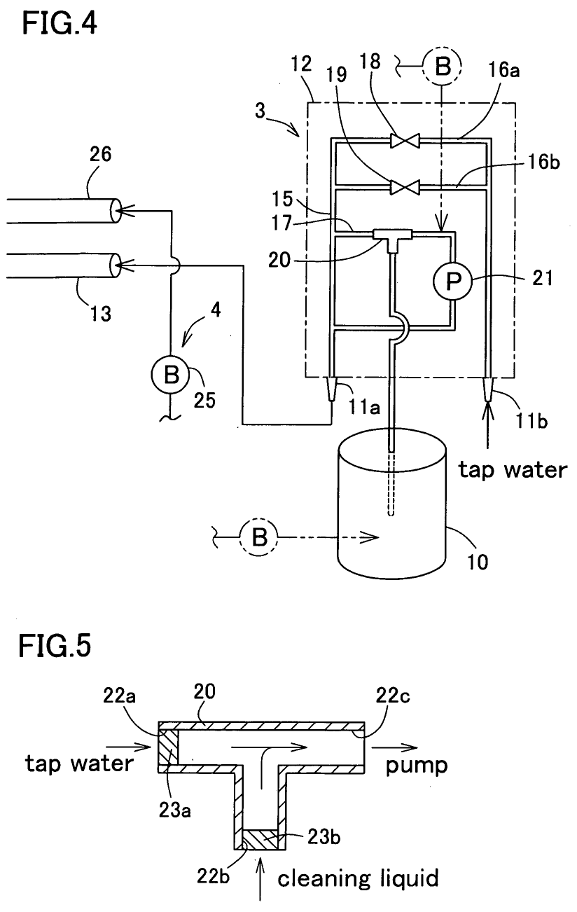

As shown in FIG. 4, the liquid supply means 3 comprises a cleaning liquid tank 10 which stores cleaning liquid, a liquid supply unit 12 having a pair of connecting nozzles 11a, 11b and a liquid supply pipe 13 connected to one connecting nozzle 11a of the liquid supply unit 12. This cleaning liquid tank 10 and liquid supply unit 12 are disposed on the plinth surface W or the floor surface F of a room R. The liquid supply pipe 13 is disposed on the plinth surface W so as to surround the floor surface F above the floor surface F. A water hose (not shown) for supplying tap water is connected to the other connecting nozzle 11b. Within this liquid supply unit 12, in a linkage pipe 15 for linking a pair of the connecting nozzles 11a, 11b, a pair of branch routes 16a, 16b branched in parallel and a bypass route 17 are formed. A dilution water supply valve 18 is provided on one branch route 16a and a cleaning liquid supply valve 19 is provided on the other branch route 16b.

The bypass route 17 has a synthetic resin T-shaped joint pipe 20 and a sending pump 21. As shown in FIG. 5, this joint pipe 20 has a water intake port 22a through which tap water flows in, a cleaning liquid intake port 22b which is connected to the cleaning liquid tank 10 and through which the cleaning liquid flows in and a flow outlet port 22c connected to the side of the sending pump 21. This water intake port 22a has a water amount adjusting chip 23a and the cleaning liquid intake port 22b has a cleaning liquid adjusting chip 23b. The cleaning liquid is diluted sufficiently (diluted 1000 times with 3 liter of water per minute) by adjusting the respective adjusting chips 23a, 23b. The sending pump 21 and the respective water supply valves 18, 19 are controlled appropriately by a control means (not shown) and when foaming, the sending pump 21 and the dilution water valve 18 are operated and cleaning liquid diluted by the joint pipe 20 is supplied to the respective foaming devices 2a-2d. On the other hand, when spraying, only the cleaning liquid supply valve 19 is operated, so that water is supplied to the respective foaming devices 2a-2d.

The air supply means 4 comprises a sending blower 25 disposed on the plinth surface W or the floor surface F of a room R via appropriate fixing devices and an air supply pipe 26 connected to this sending blower 25. This air supply pipe 26 is disposed on the plinth surface W so as to surround the floor surface F above the floor surface F. This sending blower 25 is operated under a control of an appropriate control means so as to be operated when foaming and supply air to the respective foaming devices 2a-2d through the air supply pipe 26. As a result, cleaning liquid is mixed with air in the respective foaming devices 2a-2d and foamed.

Plural liquid supply pipes 29 are disposed in a vertical direction via appropriate fixing devices on the plinth surface W. The foaming devices 2a-2d are connected to the top end of each liquid supply pipe 29. The central portions in the axial direction of the division pipes 6a-6d extending in the horizontal direction are connected to the bottom ends of the liquid supply pipes 29.

The ends in the axial direction of the division pipes 6a-6d may be connected to the bottom ends of the liquid supply pipes 29.

The division pipes 6a-6d are formed cylindrically with both ends in the axial direction closed as shown in FIG. 6. Plural supply ports 33 are formed in the peripheral face of each division pipe 6a-6d at a predetermined interval along the axial direction. A pair of drainage valves 34a, 34b are provided in the peripheral face near the ends in the axial direction of each division pipe 6a-6d. These drainage valves 34a, 34b are operated under a control of an appropriate control means so as to be operated after spraying and discharge water left in each division pipe 6a-6d.

(2) Operation of Floor Surface Cleaning System

Next, the operation of the floor surface cleaning system 1 having such a structure will be described. First, as shown in FIG. 4, the sending pump 21 and the dilution water supply pump 18 are operated, so that cleaning liquid is diluted appropriately with dilution water in the joint pipe 20 of the liquid supply unit 12. Then, this diluted cleaning liquid is supplied to the respective foaming devices 2a-2d through the liquid supply pipe 13. Further, the sending blower 25 is operated to supply air to the respective foaming devices 2a-2d through the air supply pipe 26.

Then, cleaning liquid is mixed with air in the respective foaming devices 2a-2d and foamed and the foamed cleaning liquid is supplied to the plurality of division pipes 6a-6d with a substantially equal pressure through the liquid supply pipe 29. Then, the supplied cleaning liquid is sprayed to the floor surface F from the supply ports 33 in the respective division pipes 6a-6d and kept left as it is for a while (see FIG. 1).

After a predetermined time elapses, the cleaning liquid supply valve 19 is operated so that tap water is supplied to the respective foaming devices 2a-2d through the liquid supply pipe 13. Further, this water is supplied to the plurality of division pipes 6a-6d through the foaming devices 2a-2d and the liquid supply pipe 29 and sprayed to the floor surface F from the supply ports 33 in the respective division pipes 6a-6d. Consequently, contamination on the floor surface F is washed out by this sprayed water together with the cleaning liquid and drained into the drainage S.

After the spraying, water left in the respective division pipes 6a-6d is discharged due to operation of the drainage valves 34a and 34b

(3) Effect of the Example

According to the example 1, the liquid supply means 3 and the air supply means 4 are connected to the upstream side of the plurality of foaming devices 2a-2d. The plurality of division pipes 6a-6d are connected to the downstream side of the respective foaming devices 2a-2d through the liquid supply pipe 29. Consequently, cleaning liquid foamed by the respective foaming devices 2a-2d can be supplied at a substantially equal pressure with an excellent foaming condition to the plurality of division pipes 6a-6d. Thus, even if the floor surface F of a room R which is a supply object is relatively wide, the cleaning liquid in the excellent foaming condition can be sprayed uniformly to the floor surface F of this room R. Then, after it is kept left as it is for a while, by spraying water to the floor surface F, the cleaning liquid can be washed out together with contamination on the floor surface F.

When water is sprayed to the floor surface F, the interiors of the liquid supply pipe 13, the respective foaming devices 2a-2d, the liquid supply pipe 29 and the respective division pipes 6a-6d are washed out with water, so that these individual components can be kept clean.

When this floor surface cleaning system 1 is installed, the division pipes 6a-6b can be disposed avoiding a portion corresponding to a door D of the room R (see FIG. 1), so that any complicated laying work like conventional is not necessary, thereby performing that laying work in a simple manner at a low cost.

Because water left in the respective division pipes 6a-6d is discharged after water is sprayed to the floor surface F, cleaning liquid in an excellent foaming condition can be sprayed from the division pipes 6a-6d to the floor surface F without being diluted.

The present invention is not restricted to the first example but may be modified in various ways within the scope of the present invention depending on its purpose or application. Although in the example 1, the plurality of division pipes 6a-6d connected to the downstream side of the respective foaming devices 2a-2d are exemplified as the foamed liquid supply means, the present invention is not restricted to this example. For example, a single pipe member 35 disposed surrounding the floor surface F can be exemplified as a foamed liquid supply means as shown in FIG. 7. In this case, the interior space of the pipe member 35 is sectioned to a plurality of section chambers corresponding to the plurality of foaming devices 2a-2d. As shown in FIG. 8(a), the foamed liquid supply means may be constructed with end portions 37a of a vertical pipe 37 having a supply port 36. Further, as shown in FIG. 8(b), the foamed liquid supply means may be constructed with a branch supply member 39 having a plurality of supply ports 38, 38 attached to the end portion 37a of the vertical pipe 37.

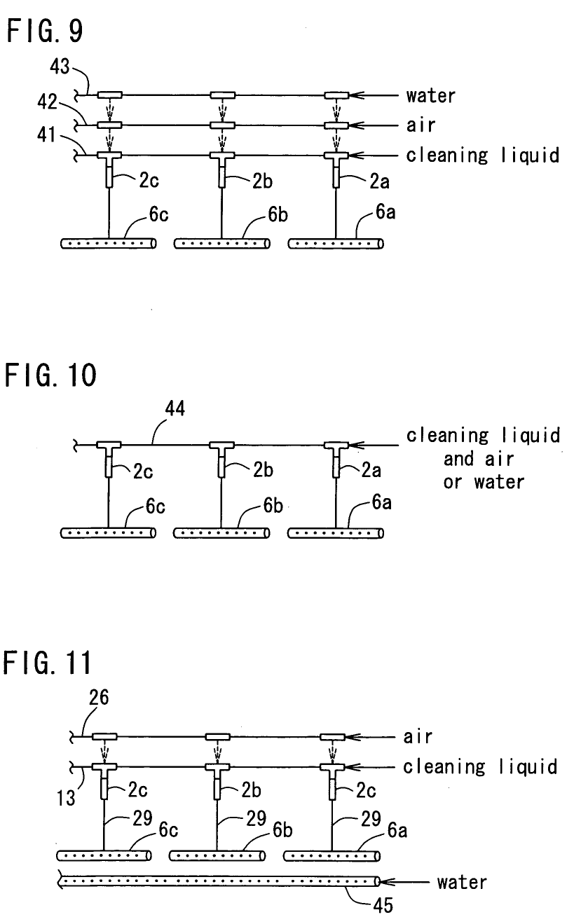

Although the first example includes two pipes; the liquid supply pipe 13 for supplying cleaning liquid or water alternately to the respective foaming devices 2a-2d and the air supply pipe 26 for supplying air to the respective foaming devices 2a-2d, the present invention is not restricted to this example. As shown in FIG. 9, the system may be constituted of a cleaning liquid supply pipe 41 for supplying cleaning liquid to the respective foaming devices 2a-2d, an air supply pipe 42 for supplying air to the respective foaming devices 2a-2d and a water supply pipe 43 for supplying water to the respective foaming devices 2a-2d. Alternatively, the system may be constituted of a single air/liquid supply pipe 44 aimed for supplying cleaning liquid mixed with air to the respective foaming devices 2a-2d and additionally water.

Although according to the first example, water is sprayed to the floor surface F through the respective division pipes 6a-6d, the present invention is not restricted to this example. For example, it is permissible to provide a single water supply pipe 45 in the vicinity of the respective division pipes 6a-6d as shown in FIG. 11, so that water is sprayed to the floor surface from this water supply pipe 45 not through the respective division pipes 6a-6d.

Although according to the first example, the respective foaming devices 2a-2d are attached to the top ends of the liquid supply pipes 29, the present invention is not restricted to this example. For example, the respective foaming devices 2a-2d may be provided at the bottom ends of the respective liquid supply pipes 29 as shown with a phantom line in FIG. 2. Further, it is permissible to use the foaming devices 2a-2d indicated with the solid line in FIG. 2 with the foaming devices 2a-2d indicated with the phantom line so as to reform already foamed cleaning liquid. Consequently, the cleaning liquid in an excellent foaming condition can be sprayed to a wider cleaning object.

As shown in FIG. 4 with the phantom line, it is permissible to provide a pipe and a sending blower B for mixing cleaning liquid in the cleaning liquid tank 10 with air (or bubbles) or a pipe and the sending blower B for mixing air (or bubbles) in diluted cleaning liquid flowing through the bypass route 17. Consequently, the cleaning liquid can be supplied to the respective foaming devices 2a-2b in a condition in which it is mixed with air (or bubbles) preliminarily, so that the cleaning liquid is foamed more effectively by this foaming device to obtain an excellent foaming condition.

### SECOND EXAMPLE

(1) Construction of Floor Surface Cleaning System (Quadruple Pipe Unit Type)

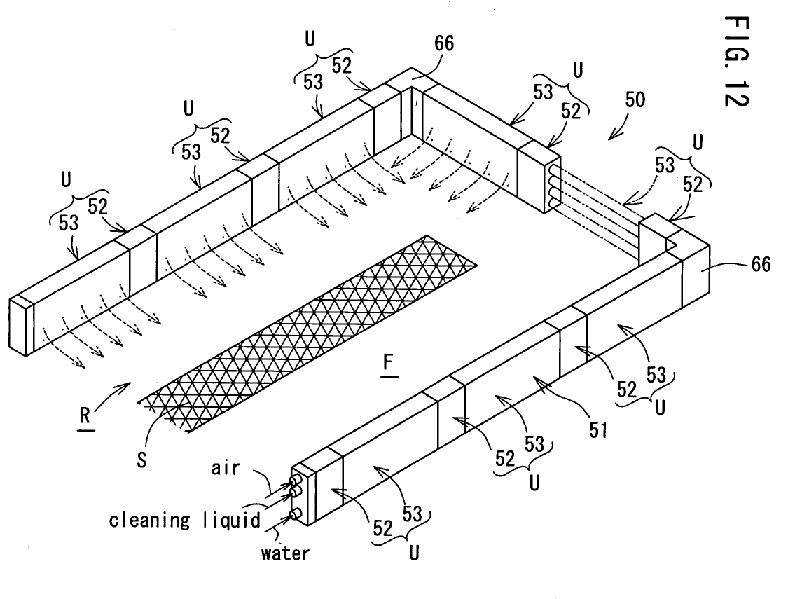

The floor surface cleaning system 50 of the second example includes a unit linkage body 51 of a substantially fallen U shape in its plan view, disposed so as to surround the floor surface F of the room R which is a supply object as shown in FIG. 12. This unit linkage body 51 is constructed by combining a plurality of foaming units U each consisting of a foaming block 52 and a passage block 53.

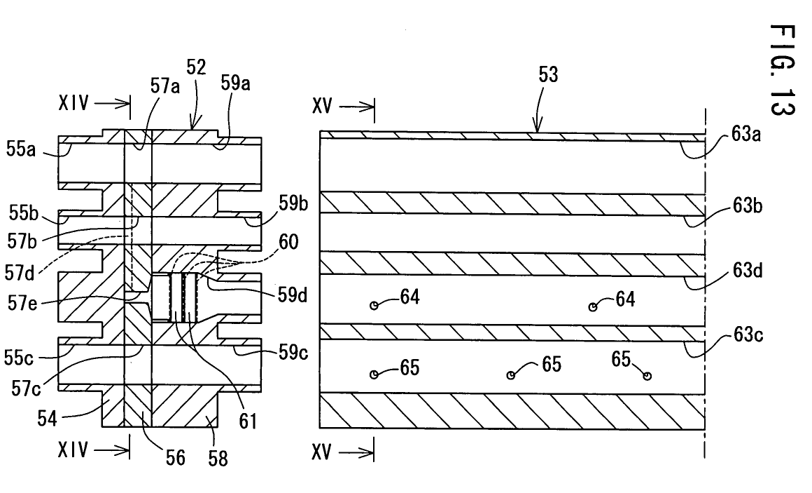

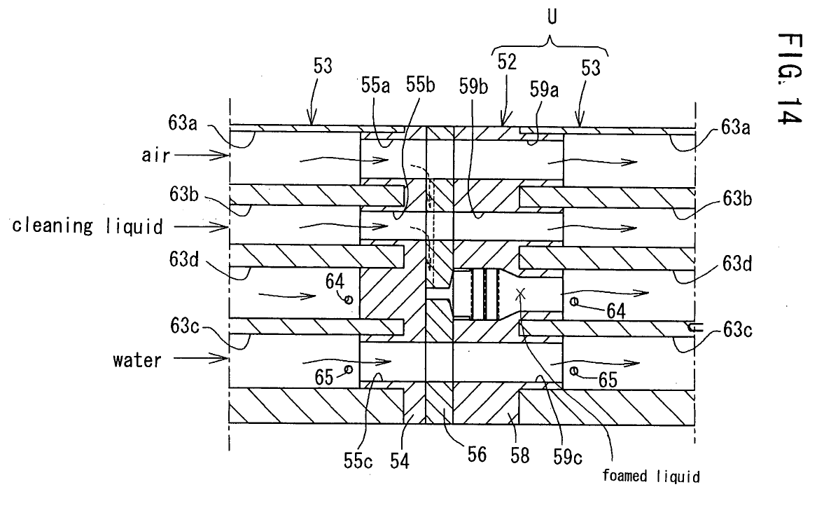

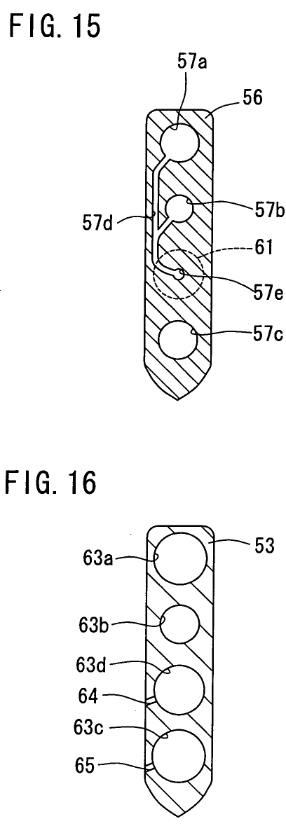

As shown in FIGS. 13, 14, this foaming block 52 has right and left cap members 54, 58 engaging end portions in the axial direction of the passage block 53 and a linkage member 56 bonded between the both cap members 54 and 58. An air flow path 55a, a cleaning liquid flow path 55b and a water flow path 55c are formed in parallel in this left cap member 54. In the linkage member 56, an air passage 57a which is connected to the air flow path 55a in the cap member 54, a cleaning liquid passage 57b which is connected to the cleaning liquid flow path 55b and a water passage 57c which is connected to the water flow path 55c are formed. As shown in FIG. 15, an mixing passage 57c which communicates with the air passage 57a and the cleaning liquid passage 57b through a linkage path 57d is formed in this linkage member 56. In the right cap member 58 are formed an air flow path 59a communicating with the air passage 57a in the linkage member 56, a cleaning liquid flow path 59b communicating with the cleaning liquid passage 57b, a water passage 59c communicating with the water passage 57c and a foaming passage 59d communicating with a mixing passage 57e. Plural (three in the Figure) net-like bodies 60 (for example, 20 mm in dia., 60 meshes) are attached on this foaming passage 59d along the axial direction through a spacer 61.

Thus, in the foaming block 52, air and cleaning liquid flowing into the air flow path 55a and cleaning liquid flow path 55b in the cap member 54 are mixed in the mixing passage 57e of the linkage member 56. The cleaning liquid mixed with air is foamed by the net-like body 60 when it passes the foaming passage 59d in the cap member 58 and then, the foamed cleaning liquid flows out of the foaming passage 59d.

As shown in FIG. 16, an air supply path 63a, a cleaning liquid supply path 63b, a water supply path 63c and a foamed liquid supply path 63d are formed in parallel in the aforementioned passage block 53. In this passage block 53, a plurality of supply ports 64 (exemplified as supply nozzle) which communicate with the foamed liquid supply path 63d and are open outward are formed at a predetermined interval (for example, every 100 mm) along the axial direction. Further, in the passage block 53, a plurality of supply ports 65, which communicate with the water supply path 63c and are open outward, are formed at a predetermined interval (for example, every 60 mm) along the axial direction. In the condition in which this passage block 53 and the foaming block 52 are connected, in each foaming unit U, the air supply path 63a and the air flow path 59a are linked, the cleaning liquid supply path 63b and the cleaning liquid flow path 59b are linked, the water supply path 63c and the water flow path 59c are linked and further, the foamed liquid supply passage 63d and the foaming passage 59d are linked. Between adjacent foaming units U, respective air supply paths 63a, cleaning liquid supply paths 63b and water supply paths 63c are linked with each other and the foamed liquid supply paths 63d are sectioned.

According to the second example, the air supply path of the present invention is constructed with the air flow path 55a, the air passage 57a, the air flow path 59a, and the air supply path 63a and the like. Further, the surface active agent supply path of the present invention is constructed with the cleaning liquid flow path 55b, the cleaning liquid passage 57b, the cleaning liquid flow path 59b and the cleaning liquid supply path 63b and the like. The foamed liquid supply path of the present invention is constructed with the foaming passage 59d and the foamed liquid supply path 63d and the like. Further, the water supply path of the present invention is constructed with the water flow path 55c, the water passage 57c, the water flow path 59c and the water supply path 63c and the like.

At a corner, as shown in FIG. 12, adjacent foaming units U are linked with each other through a substantially L-shaped linkage block 66 in which appropriate linkage paths (not shown) are formed. This linkage block 66 is preferred to be curved from the viewpoints of fluidity of fluid.

(2) Operation of Floor Surface Cleaning System

Next, the operation of the floor surface cleaning system 50 having the above-described structure will be described. When cleaning, as shown in FIG. 12, air and cleaning liquid are supplied to the unit linkage body 51 from an end portion thereof so that air and cleaning liquid are supplied to each foaming unit U substantially equally. Then, cleaning liquid is mixed with air and foamed in the foaming block 52 of each foaming unit U. That foamed cleaning liquid is sprayed to the floor surface F from the plurality of supply ports 64 through the foamed liquid supply path 63d in the passage block 53 and kept left under that spraying condition for a while.

After a predetermined time elapses, water is supplied to the linkage unit 51 from an end portion and the water is supplied to individual foaming units U substantially equally. Then, water is sprayed to the floor surface F from the plurality of supply ports 65 through the water supply path 63c in the passage block 53. Therefore, contamination on the floor surface F is washed out together with the cleaning liquid by this sprayed water and drained into the drainage S.

(3) Effect of the Example

According to the second example, the unit linkage body 51 constituted of a plurality of foaming units U is provided and air and cleaning liquid are supplied to this unit linkage body 51 from an end portion thereof. The cleaning liquid is mixed with air in the foaming block 52 of each foaming unit U and in the passage block 53 of each foaming unit U, the foamed cleaning liquid is sprayed to the floor surface F from the supply ports 64 through the foamed liquid supply path 63d. Consequently, even if the floor surface F of the room R which is a supply object is relatively wide, the cleaning liquid in an excellent foaming condition can be sprayed uniformly on this floor surface F. After it is left with this spraying condition for a while, water is supplied from an end of the unit linkage body 51 and water is sprayed to the floor surface F from the supply ports 65 through the water supply path 63c in the passage block 53 of each foaming unit U to wash away the cleaning liquid together with the contamination on the floor surface F.

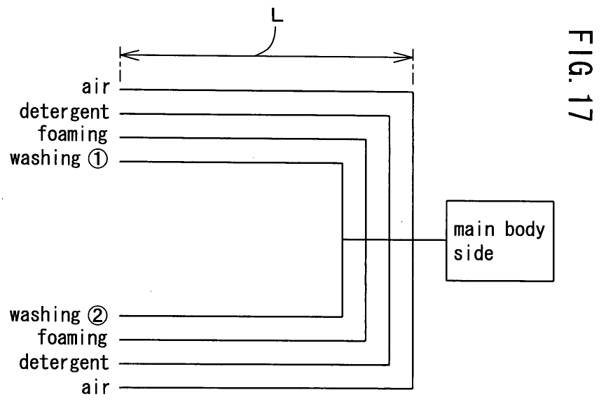

Because according to the second example, as shown in FIG. 14, the water supply path 63c is independent of the air supply path 63a, the cleaning liquid supply path 63b and the foamed liquid supply path 63d, although much water is sprayed from the foaming unit U near the main body (water supply source), sometimes, only a small amount of water is spouted from the foaming unit U apart from the main body. Then, as shown in FIG. 17, a washing No. 1 path and a washing No.2 path are divided at the central portion and the main body is connected to that divided portion. As a result, excellent washing condition can be obtained even if the distance L is about 10-12 m. In the meantime, for a small type in which the distance L is less than 10 m, only the washing No.1 path is employed (shown in FIG. 12).

Because according to the second example, as shown in FIG. 15, the air passage 57a, the cleaning liquid passage 57b and the foaming passage 59d are linked through the linkage path 57d and the mixing path 57c in the throttle portion (orifice), the foamed liquid, air and cleaning liquid are distributed equally even if they are fed with the distance L shown in FIG. 17 set to about 20 m.

### THIRD EXAMPLE

(1) Construction of Floor Surface Cleaning System (Triple Pipe Unit Type)

For the floor surface cleaning system of the third example, like reference numerals are attached to the same components as the second example and description thereof is omitted.

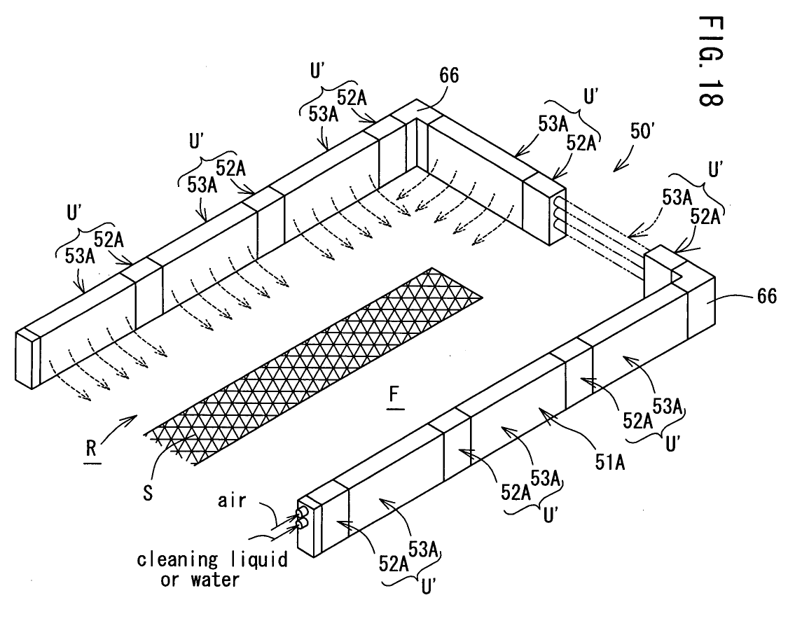

The floor surface cleaning system 50′ of the third example includes a unit linkage body 51A of a substantially fallen U shape in its plan view, disposed so as to surround the floor surface F of the room R which is a supply object as shown in FIG. 18. This unit linkage body 51A is constructed by linking a plurality of foaming units U′ each consisting of a foaming block 52A and a passage block 53A.

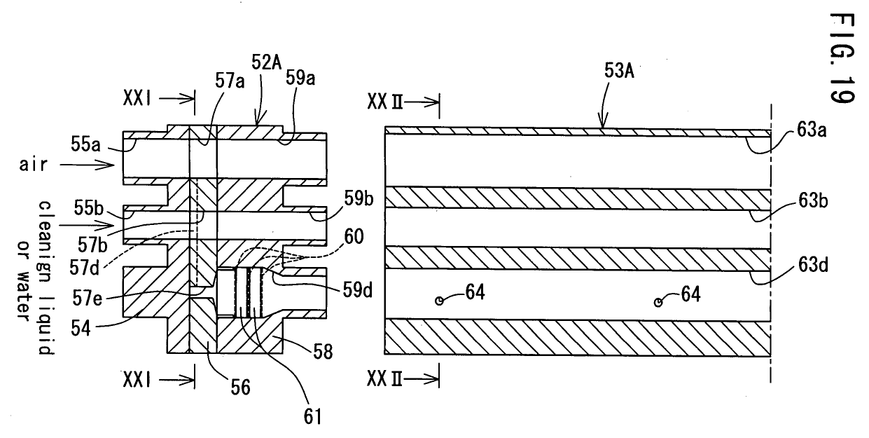

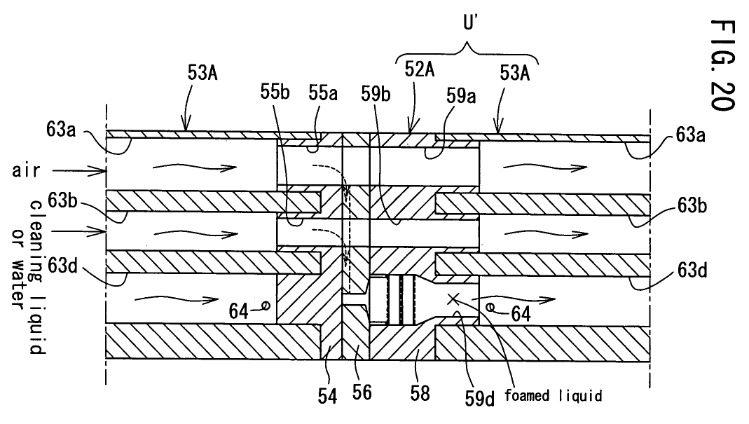

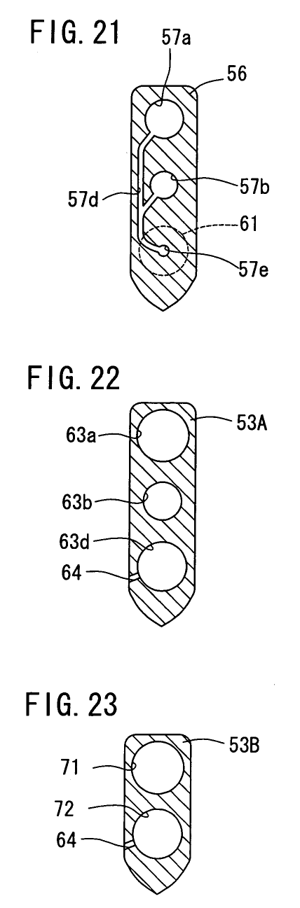

As shown in FIGS. 19, 20, this foaming block 52A has right and left cap members 54, 58 engaging end portions in the axial direction of the passage block 53A and a linkage member 56 bonded between the both cap members 54 and 58. An air flow path 55a and a cleaning liquid flow path 55b are formed in parallel in this left cap member 54. In the linkage member 56, an air passage 57a which is connected to the air flow path 55a in the cap member 54 and a cleaning liquid passage 57b which is connected to the cleaning liquid flow path 55b are formed. As shown in FIG. 21, an mixing passage 57e which communicates with the air passage 57a and the cleaning liquid passage 57b through the linkage path 57d is formed in this linkage member 56. In the right cap member 58 are formed an air flow path 59a communicating with the air passage 57a in the linkage member 56, a cleaning liquid flow path 59b communicating with the cleaning liquid passage 57b, and a foaming passage 59d communicating with a mixing passage 57e. Plural (three in the Figure) net-like bodies 60 (for example, 20 mm in dia., 60 meshes) are attached on this foaming passage 59d along the axial direction through a spacer 61.

Thus, in the foaming block 52, air and cleaning liquid flowing into the air flow path 55a and cleaning liquid flow path 55b in the cap member 54 are mixed in the mixing passage 57e of the linkage member 56. The cleaning liquid mixed with air is foamed by the net-like body 60 when it passes the foaming passage 59d in the cap member 58 and then, the foamed cleaning liquid flows out of the foaming passage 59d.

As shown in FIG. 22, an air supply path 63a, a cleaning liquid supply path 63b, and a foamed liquid supply path 63d are formed in parallel in the aforementioned passage block 53A. In this passage block 53A, a plurality of supply ports 64 (exemplified as supply nozzle) which communicate with the foamed liquid supply path 63d and are open outward are formed at a predetermined interval (for example, every 100 mm) along the axial direction. In the condition in which this passage block 53A and the foaming block 52A are connected, in each foaming unit U′, the air supply path 63a and the air flow path 59a are linked, the cleaning liquid supply path 63b and the cleaning liquid flow path 59b are linked, and further, the foamed liquid supply path 63d and the foaming passage 59d are linked. Between adjacent foaming units U′, respective air supply paths 63a and cleaning liquid supply paths 63b are linked with each other and the foamed liquid supply paths 63d are sectioned.

According to the third example, the air supply path of the present invention is constructed with the air flow path 55a, the air passage 57a, the air flow path 59a, and the air supply path 63a and the like. Further, the surface active agent supply path of the present invention is constructed with the cleaning liquid flow path 55b, the cleaning liquid passage 57b, the cleaning liquid flow path 59b and the cleaning liquid supply path 63b and the like. The foamed liquid supply path of the present invention is constructed with the foaming passage 59d and the foamed liquid supply path 63d and the like. When washing, water is supplied to the cleaning liquid supply path 63b.

At a corner, as shown in FIG. 18, adjacent foaming units U are linked with each other through a substantially L-shaped linkage block 66 in which appropriate linkage paths (not shown) are formed. This linkage block 66 is preferred to be curved from the viewpoints of fluidity of fluid.

(2) Operation of Floor Surface Cleaning System

Next, the operation of the floor surface cleaning system 50′ having the above-described structure will be described. When cleaning, as shown in FIG. 18, air and cleaning liquid are supplied to the unit linkage body 51A from an end portion thereof so that air and cleaning liquid are supplied to each foaming unit U′ substantially equally. Then, cleaning liquid is mixed with air and foamed in the foaming block 52A of each foaming unit U′. That foamed cleaning liquid is sprayed to the floor surface F from the plurality of supply ports 64 through the foamed liquid supply path 63d in the passage block 53A and kept left under that spraying condition for a while.

After a predetermined time elapses, water is supplied to the linkage unit 51A from an end portion and the water is supplied to individual foaming units U substantially equally. Then, water is sprayed to the floor surface F from the plurality of supply ports 65 through the water supply path 63d in the passage block 53A. Therefore, contamination on the floor surface F is washed away together with the cleaning liquid by this sprayed water and drained into the drainage S.

(3) Effect of the Example

According to the third example, the unit linkage body 51A constituted of a plurality of foaming units U′ is provided and air and cleaning liquid are supplied to this unit linkage body 51A from an end portion thereof. The cleaning liquid is mixed with air in the foaming block 52 of each foaming unit U′ and in the passage block 53 of each foaming unit U′, the foamed cleaning liquid is sprayed to the floor surface F from the supply ports 64 through the foamed liquid supply path 63d. Consequently, even if the floor surface F of the room R which is a supply object is relatively wide, the cleaning liquid in an excellent foaming condition can be sprayed uniformly on this floor surface F. After it is left with this spraying condition for a while, water is supplied from an end of the unit linkage body 51A and water is sprayed to the floor surface F from the supply ports 64 through the foamed liquid supply path 63d in the passage block 53 to wash away the cleaning liquid together with the contamination on the floor surface F.

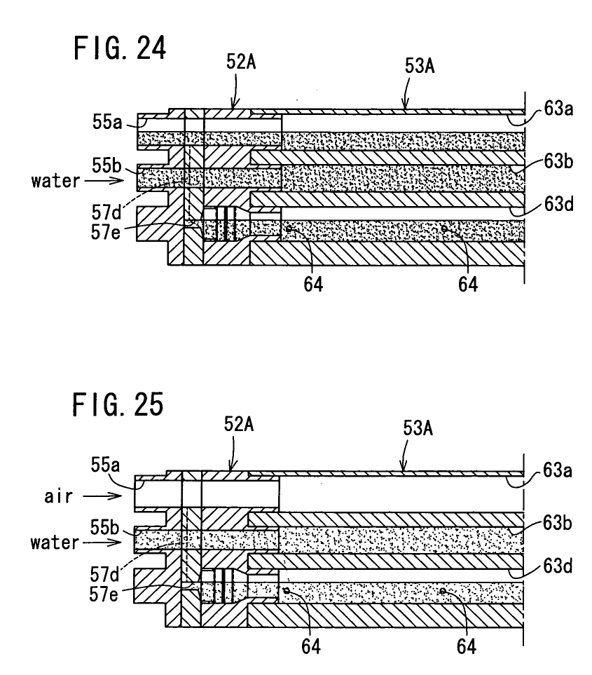

Although according to the third embodiment, as shown in FIG. 24, the cleaning liquid supply path 63b is used as a water supply path for washing also, because discharged water passes the throttle portion (linkage path 57d and mixing path 57e), most water reaches a foaming unit U′ far away from a foaming unit U′ near the main body (water supply source), so that water is discharged equally from the foamed liquid supply path 63d of the foaming unit U′.

If as shown in FIG. 25, air is supplied to the air supply path 63a at the same time when water is supplied to the cleaning liquid supply path 63b when washing, because a high pressure is applied to the air supply path 63a, water is more likely to enter into the foamed liquid supply path 63d without returning to the air supply path 63a, so that water is spouted aggressively. As a result, the respective foaming units U′ are supplied with water uniformly, so that water pressure increases and washing force for washing away contamination increases. Even if water is allowed to flow out with the distance L set to about 16 m in FIG. 17, water is distributed equally.

The present invention is not restricted to the second and third examples, but may be modified within the scope of the invention depending on the purpose or application. In addition to the quadruple pipe unit type of the second example and triple pipe unit type of the third example, as shown in FIG. 23, a cleaning liquid supply path 71 and a foamed liquid supply path 72 are formed in the foaming unit U and the cleaning liquid supply path 71 is capable of supplying water. It is permissible to first, supply the cleaning liquid mixed with air to the cleaning liquid supply path 71, spray the foamed liquid to the floor surface, after a predetermined time elapses, and supply water to the cleaning liquid supply path 71 to wash away the foamed liquid from the floor surface. Consequently, each foaming unit U can be formed in an extremely compact and cheap form and the cleaning liquid adhering to and remaining on the net-like bodies 60 constituting the foaming portion can be washed away, thereby suppressing generation of mildew, deposit and the like.

When stock solution is used as the cleaning liquid, it is permissible to supply dilution water together with stock solution of the cleaning liquid to the aforementioned cleaning liquid supply paths 63b, 71 and after a predetermined time elapses, supply only water to the cleaning liquid supply paths 63b, 71.

### OTHER EXAMPLES

Next, as examples for supplying the cleaning liquid and water in the foaming systems of the first-third examples, following examples (1)-(4) will be described. In the meantime, like reference numerals are attached to the same components as the first-third examples and description thereof is omitted.

According to the above-described example (1), as shown in FIG. 26, the foaming portion (or foaming device) and the water supply source (for example, cock for tap water) are linked with each other through a first linkage path 101. A washing electromagnetic valve 104a is provided in the midway of this first linkage path 101. The upstream side and the downstream side of the washing electromagnetic valve 104a of this first linkage path 101 are connected through a bypass route 105. A dilution electromagnetic valve 104b and a water control unit 99 are provided in the midway of this bypass route 105. The downstream side of the water control unit 99 of the bypass route 105 and a tank 10 which stores cleaning liquid are connected through a second linkage path 102. A T-shaped joint pipe 108 is provided in the linkage portion between the bypass route 105 and the second linkage path 102. A liquid pump 106 for sending cleaning liquid from the tank 10 is provided in the midway of this second linkage path 102. The foaming portion (or foaming device) and an air pump 107 are connected through a third linkage path 103. Further, a control circuit 109 for controlling the washing electromagnetic valve 104a, the dilution electromagnetic valve 104b, the liquid pump 106 and the air pump 107 are provided.

As the aforementioned foaming portion, for example, the cleaning liquid flow path 55b in the foaming blocks 52, 52A of the second and third examples can be exemplified. As the aforementioned foaming device, for example, the foaming device 2 of the first example can be exemplified.

When cleaning liquid is supplied to a supply object, as shown in FIG. 27, the washing electromagnetic valve 104a is closed (turned OFF) by the control circuit 109 and the dilution electromagnetic valve 104b is always opened (turned ON) after a predetermined time passes. Further, the liquid pump 106 is always started (turned ON) after a predetermined time passes. Further, the air pump 107 is always started (turned ON) by the control circuit 109 after a predetermined time passes. Then, dilution water whose flow amount is throttled is supplied to the bypass route 105 by the water control unit 99. Cleaning water is sent to the second linkage path 102 by the liquid pump 106 and the cleaning liquid is mixed with the dilution water by the T-shaped joint pipe 108. That diluted cleaning liquid is supplied to the foaming portion (or foaming device). Further, air is supplied to the foaming portion (or foaming device) by the operation of the air pump 107. As a result, the cleaning liquid diluted in the foaming portion (or foaming device) is mixed with air and foamed and after that, that foamed cleaning liquid is supplied to a supply object.

On the other hand, when water is supplied to the supply object, the dilution electromagnetic valve 104b is closed (turned OFF) by the control circuit 109 and the liquid pump 106 and the air pump 107 are stopped (turned OFF). Further, the washing electromagnetic valve 104a is always opened (turned ON) after a predetermined time passes. Then, water is supplied to the foaming portion (or foaming device) through the first linkage path 101 and after that, supplied to the supply object.

According to the example (1), it is necessary to replace the water control unit 99 or change the discharge size of the liquid pump 106 depending on the quantity, size and the like of the foaming portions to adjust the site corresponding to the foaming area. Therefore, because the replacement works for the water control unit 99, the liquid pump 106 and the like are complicated and the part installation positions are limited, the entire system becomes relatively expensive and complicated.

Then, the example (2) to solve the aforementioned problems will be described.

In, the example (2), as shown in FIG. 28, the foaming portion (or foaming device) and the water supply source (for example, cock for tap water) are connected through a first linkage path 111. An electromagnetic valve 114 is provided in the midway of this first linkage path 111. The downstream side of the electromagnetic valve 114 of this first linkage path 111 and the tank 10 which stores cleaning liquid are connected through the second linkage path 112. A T-shaped joint pipe 118 is provided in the linkage portion between the first linkage path 111 and the second linkage path 112. A liquid pump 116 for sending cleaning liquid from the tank 10 is provided in the midway of the second linkage path 112. The foaming portion (or foaming device) and the air pump 117 are connected through the third linkage path 113. Further, a control circuit 119 for controlling the electromagnetic valve 114, the liquid pump 116 and the air pump 117 is provided.

The control circuit 119 is capable of turning ON/OFF the electromagnetic valve 114 and the liquid pump 116 repeatedly through pulse signals. This control circuit 119 includes a memory portion 119a for memorizing the ratio (t1/t2, t3/t4; see FIG. 29) between ON time and OFF time in the repeated ON/OFF control, ON time (t1, t3), OFF time (t2, t4), repeat number (in FIG. 29, electromagnetic valve; seven times, liquid pump; five times) and a changing portion 119b for changing respective values memorized in the memory portion 119a through an appropriate input means (for example, adjustment knob).

When cleaning liquid is supplied to the supply object as shown in FIG. 29, the electromagnetic valve 114 is opened/closed repeatedly (turned ON/OFF) by the control circuit 119 and the liquid pump 116 is started/stopped (turned ON/OFF) repeatedly. The air pump 117 is driven (turned ON) by the control circuit 119 after a predetermined time passes. Consequently, a predetermined amount of dilution water is supplied to the first linkage path 111. Further, a predetermined amount of cleaning liquid is sent to the second linkage path 112 by the operation of the liquid pump 116 and that cleaning liquid is mixed with dilution water and diluted in the T-shaped joint pipe 118 and the diluted cleaning liquid is supplied to the foaming portion (or foaming device). Further, air is supplied to the foaming portion (or foaming device) by the operation of the air pump 117. Consequently, the diluted cleaning liquid is mixed with air and foamed in the foaming portion (or foaming device) and after that, the foamed cleaning liquid is supplied to the supply object.

On the other hand, when water is supplied to the supply object, the liquid pump 116 and the air pump 117 are stopped (turned OFF) by the control circuit 119 and the electromagnetic valve 114 is opened after a predetermined time passes. Consequently, water is supplied to the foaming portion (or foaming device) through the first linkage path 111 and supplied to the supply object.

Although according to the above described examples, the electromagnetic valve 114 is kept open when water is supplied to the supply object, the present invention is not restricted to this example, but the electromagnetic valve 114 may be opened/closed (turned ON/OFF) repeatedly depending on the quantity, size and the like of the foaming portion (or foaming device).

According to the example (2), the dilution electromagnetic valve 104b and the water control unit 99 can be omitted from the example (1), thereby the entire system being constructed with a cheap and simple structure. Further, the ratio of ON/OFF of the electromagnetic valve 114 and the liquid pump 116, each time interval, repeat number and the like can be changed appropriately depending on the foaming area (that is, quantity, size and the like of the foaming portions and foaming devices) of a supply object, contamination and the like and the dilution water amount, the dilution ratio and the like of the surface active agent solution can be changed easily. Further, no adjustment work about the quantity of liquid (discharge amount) by the liquid pump 116 (motor rotation number) is necessary even if the power frequency changes in Kansai district, Kanto district or the like.

Assume that the diameter of a pipe of the first linkage path 111 is 1/2 inch, water quantity of about 30 L/min is obtained and the discharge capacity of the liquid pump 116 is 100 cc/min. Then, a case where the dilution ratio of the surface active agent is set to 1/100 and the amount of dilution water is 5 L/min will be described.

To obtain a dilution amount of 5 L/min, the ratio between the ON time t1 and OFF time t2 of the electromagnetic valve 114 is set to 5 L/30 L, that is, the OFF time is set to 6 to the ON time of 1.

To obtain a dilution ratio of 1/100, it is necessary to send cleaning liquid whose dilution water amount is 1/100 5 L/min, that is, 50 cc/min. Therefore, by setting the ratio between the pump ON time t3 and OFF time t3 to ½, a pump performance of 50 cc/min can be obtained.

If the interval between ON and OFF of the electromagnetic valve 114 and the liquid pump 116 is expanded, even if the dilution water amount and dilution ratio of the surface active agent solution are the same, there sometimes occurs an unevenness in that interval.

Thus, if the repeat number of the ON/OFF is increased with the ratio between ON and OFF being constant, the same result occurs as when the liquid pump is operated continuously, so that unevenness in the dilution water amount and dilution ratio diminishes.

Because the service life of the electromagnetic valve 114 is affected by an excessive increase in the repeat number of the ON/OFF, it is necessary to set an appropriate repeat number of the ON/OFF.

Here, the example (3) capable of reducing the unevenness in the dilution water amount and dilution ratio of the surface active agent solution without increasing the repeat number of the ON/OFF extremely will be described.

The example (3) has the same configuration as the example (2) and like reference numerals are attached to the same components and detailed description thereof is omitted. A different point between the example (3) and the example (2) is that as shown in FIG. 30, there is provided a storage container 120 for storing cleaning liquid on the downstream side of the linkage portion between the first linkage path 111 and the second linkage path 112. Consequently, after the cleaning liquid is mixed with dilution water, it is collected in the storage container 120 temporarily and after the unevenness in the dilution water amount and dilution ratio are reduced, it is supplied to the foaming portion (or foaming device). This storage container 120, for example, can be constructed with a pipe having a larger diameter than the pipe constituting the first linkage path 111 and a predetermined length.

As shown in FIG. 30 with the phantom line, the storage container 121 for storing air may be provided in the midway of the third linkage path 113.

Next, when a plurality of foaming portions (or foaming devices) are divided to a circuit A and a circuit B, the example (4) which is preferable for a case where as shown in FIG. 17, a plurality of foaming portions (or foaming devices) disposed on the left side of a supply object are set to the circuit A while a plurality of foaming portions (or foaming devices) disposed on the right side of the supply object are set to the circuit B will be described.

The example (4) has substantially the same configuration as the example (2) and like reference numerals are attached to the same components and detailed description thereof is omitted. The different point between the example (4) and the example (2) is that as shown in FIG. 31, the downstream side of the first linkage path 111 is branched to branch routes 111a, 111b while the respective branch routes 111a, 111b are provided with electromagnetic valves 122, 123 and the downstream side of the third linkage path 113 is branched to branch routes 113a, 113b while the respective branch routes 113a, 113b are provided with electromagnetic valves 124, 125. Then, the downstream sides of the branch routes 111a, 113a are connected to the foaming portion (or foaming device) of the circuit A, while the downstream sides of the branch routes 111b, 113b are connected to the foaming portion (or foaming device) of the circuit B. Consequently, by controlling the electromagnetic valves 122-125 appropriately, when cleaning liquid is supplied to the supply object, (1) the foamed cleaning liquid can be supplied from the foaming portion (or foaming device) of the circuit A to the supply object and after that, the foamed cleaning liquid can be supplied from the foaming portion (or foaming device) of the circuit B to the supply object or (2) the foamed cleaning liquid can be supplied to the supply object from the foaming portions (or foaming device) of the circuit A and circuit B at the same time. Likewise, by controlling the electromagnetic valves 122-125 appropriately, when water is supplied to the supply object, (1) it is possible to supply water from the foaming portion (or foaming device) of the circuit A to the supply object and then supply the water from the foaming portion (or foaming device) of the circuit B to the supply object or (2) it is possible to supply water from the foaming portions (or foaming devices) of the circuits A, B to the supply object at the same time.

### INDUSTRIAL APPLICABILITY

The present invention is applicable for cleaning system for spraying cleaning liquid to a cleaning object (for example, floor surface, plinth), a system for spraying sanitizer to sanitizing object, a system for spraying disinfectant to a disinfecting object, a system for spraying harmful insect expellent to an expelling object, a system for spraying agricultural chemical to farm and the like.

1. A foaming system comprising:
a plurality of foaming means for foaming surface active agent solution;
a foamed liquid supply means for supplying said surface active agent solution foamed by said plurality of foaming means to a supply object;
a surface active agent supply means for supplying said surface active agent solution to said plurality of foaming means;
a gas supply means for supplying gas to said plurality of foaming means; and
a water supply means for supplying water to said supply object, wherein
said foamed liquid supply means has a plurality of pipe-like members provided corresponding to said plurality of foaming means.

2. The foaming system according to claim 1 wherein said surface active agent supply means has a surface active agent supply pipe which communicates with said plurality of foaming means, said gas supply means has a gas supply pipe which communicates with said plurality of foaming means and said water supply means has a water supply pipe.

3. The foaming system according to claim 2 wherein said water supply pipe communicates with said plurality of foaming means.

4. The foaming system according to claim 3 wherein two or more of said surface active agent supply pipe, said gas supply pipe and said water supply pipe are used with the same pipes.

5. The foaming system according to claim 1 wherein said water supply means comprises a first linkage path for linking said foaming means with a water supply source and an opening/closing valve provided in the midway of the first linkage path and said surface active agent supply means comprises a second linkage path for linking the downstream side of said opening/closing valve of said first linkage path with a surface active agent supply source and a sending means which is provided in the midway of the second linkage path and sends said surface active agent solution from said surface active agent supply source to said second linkage path, said foaming system further comprising a control means for, when the foamed surface active agent solution is supplied to the supply object, turning ON/OFF said opening/closing valve repeatedly and turning ON/OFF said sending means repeatedly.

6. The foaming system according to claim 5 wherein a storage container for storing said surface active agent solution is provided in the midway of said first linkage path and in the downstream side of a linkage portion of said second linkage path.

7. The foaming system according to claim 1 wherein said foaming means is a foaming device attachable to a pipe.

8. The foaming system according to claim 1 wherein said pipe-like member is a division pipe extending in a horizontal direction.

9. The foaming system according to claim 1 wherein a discharge means for discharging water left inside the foamed liquid supply means is provided on said foamed liquid supply means.

10. The foaming system according to claim 1 which is used for cleaning the surface of at least one of the floor and the plinth of a room such as a galley.

11. A foaming system comprising:
a unit linkage body which is formed by linking a plurality of foaming units, wherein
said foaming unit has a foaming unit main body which is provided with a foaming portion for foaming surface active agent solution, a foamed liquid supply path which communicates with the foaming portion and is supplied with said surface active agent solution foamed by the foaming portion and a supply nozzle whose one end communicates with said foamed liquid supply path while the other end is open outward.

12. The foaming system according to claim 11 wherein said foaming unit main body comprises a gas supply path which communicates with said foaming portion and is supplied with gas, a surface active agent supply path which communicates with said foaming portion and is supplied with the surface active agent solution, a water supply path for supplying water to a supply object and said foamed liquid supply path.

13. The foaming system according to claim 11 wherein said foaming unit main body comprises a gas supply path which communicates with said foaming portion and is supplied with gas, a surface active agent supply path which communicates with said foaming portion and is supplied with the surface active agent solution, and said foamed liquid supply path, at least one of said gas supply path, said surface active agent supply path and said foamed liquid supply path being capable of being supplied with water.

14. The foaming system according to claim 11 further comprising: a first linkage path for linking said foaming portion with a water supply source; an opening/closing valve provided in the midway of the first linkage path; a second linkage path for linking the downstream side of the opening/closing valve of the first linkage path with a surface active agent supply source; a sending means which is provided in the midway of the second linkage path and sends said surface active agent solution from said surface active agent supply source to the second linkage path; and a control means which, when the foamed surface active agent solution is supplied to the supply object, turns ON/OFF said opening/closing valve and turns ON/OFF said sending means repeatedly.

15. The foaming system according to claim 14 wherein a storage container for storing said surface active agent solution is provided in the downstream side of the linkage portion of said second linkage path and in the midway of said first linkage path.

16. The foaming system according to claim 12 wherein said foaming portion has a throttle portion at the linkage portion between said gas supply path and said surface active agent supply path.

17. The foaming system according to claim 13 wherein said foaming portion has a throttle portion at the linkage portion between said gas supply path and said surface active agent supply path.

18. The foaming system according to claim 12 wherein in said foaming units adjacent in said unit linkage body, said foamed liquid supply path is sectioned and said gas supply path and said surface active agent supply path are connected.

19. The foaming system according to claim 13 wherein in said foaming units adjacent in said unit linkage body, said foamed liquid supply path is sectioned and said gas supply path and said surface active agent supply path are connected.

20. The foaming system according to claim 12 wherein said gas supply path, said surface active agent supply path and said foamed liquid supply path are disposed in the linkage direction of said unit linkage body.

21. The foaming system according to claim 13 wherein said gas supply path, said surface active agent supply path and said foamed liquid supply path are disposed in the linkage direction of said unit combined body.

22. The foaming system according to claim 11 which is used for cleaning the surface of at least one of the floor and the plinth of a room such as a galley.

23. A foaming method using a foaming system including:
a plurality of foaming means for foaming surface active agent solution;
a foamed liquid supply means for supplying said surface active agent solution foamed by said plurality of foaming means to a supply object;
a surface active agent supply means for supplying said surface active agent solution to said plurality of foaming means;
a gas supply means for supplying gas to said plurality of foaming means; and
a water supply means for supplying water to said supply object, wherein
said foamed liquid supply means includes a plurality of pipe-like members corresponding to said plurality of foaming means, wherein
said foaming method comprising:
supplying said surface active agent solution and said gas to said foaming means with the surface active agent supply means and said gas supply means;
mixing the surface active agent solution with the gas with the foaming means to foam;
supplying the foamed surface active agent solution from said plurality of pipe-like members to said supply object; and
after left for a predetermined time, supplying water to said supply object with said water supply means.

24. The foaming method according to claim 23 wherein said surface active agent supply means has a surface active agent supply pipe which communicates with said plurality of foaming means, said gas supply means has a gas supply pipe which communicates with said plurality of foaming means and said water supply means has a water supply pipe which communicates with the plurality of foaming means, said foaming method further comprising:
supplying said surface active agent solution to said surface active agent supply pipe while supplying said gas to said gas supply pipe;
mixing the surface active agent solution with the gas with said plurality of foaming means to foam;
supplying the foamed surface active agent solution to said supply object from said plurality of pipe-like member;
after left for a predetermined time, supplying water to said water supply pipe; and
supplying the water from said plurality of pipe-like members to said supply object through said plurality of foaming means.

25. The foaming method according to claim 24 wherein when water is supplied to said water supply pipe, gas is supplied to said gas supply pipe.

26. A foaming method using a foaming system including:
a unit linkage body which is formed by linking a plurality of foaming units, wherein
said foaming unit has a foaming unit main body which is provided with a foaming portion for foaming surface active agent solution, a foamed liquid supply path which communicates with the foaming portion and is supplied with said surface active agent solution foamed by the foaming portion and a supply nozzle whose one end communicates with said foamed liquid supply path while the other end is open outward, wherein
said foaming method comprising, in said plurality of foaming units:
said surface active agent solution foamed by said foaming portion is supplied from said respective foamed liquid supply path to said supply object.

27. The foaming method according to claim 26 wherein said foaming unit main body comprises a gas supply path which communicates with said foaming portion and is supplied with gas, a surface active agent supply path which communicates with said foaming portion and is supplied with the surface active agent solution, and said foamed liquid supply path, said surface active agent supply path being capable of being supplied with water,
said foaming method further comprising, in said foaming unit main body:
supplying said surface active agent solution to said surface active agent supply path while supplying gas to said gas supply path;
mixing the surface active agent solution with the gas in said foaming portion to foam;
supplying the foamed surface active agent solution to the supply object from said supply nozzle through said foamed liquid supply path;
after left for a predetermined time, supplying water to said surface active agent supply path; and
supplying the water to said supply object from said supply nozzles through said foaming portions and said foamed liquid supply path.

28. The foaming method according to claim 27 wherein gas is supplied to said gas supply path when water is supplied to said surface active agent supply path.
